(19) United States
(12) Patent Application Publication
(10) Pub. No.: US 2025/0214608 A1
(43) Pub. Date: Jul. 3, 2025

(54) Training a Motion Planning System for an Autonomous Vehicle

(71) Applicant: Aurora Operations, Inc., Pittsburgh, PA (US)

(72) Inventors: Trang Thu Tran Dang, Woodinville, WA (US); Vishal Dugar, San Francisco, CA (US); Pengju Jin, San Francisco, CA (US); Yuhang Ma, Pittsburgh, PA (US); Anirudh Vemula, Pittsburgh, PA (US); Arun Venkatraman, Mountain View, CA (US)

(21) Appl. No.: 18/585,943

(22) Filed: Feb. 23, 2024

Related U.S. Application Data
(60) Provisional application No. 63/616,297, filed on Dec. 29, 2023.

(51) Int. Cl. B60W 60/00; G06N 20/00

(52) U.S. Cl. CPC B60W 60/001; G06N 20/00

(57) ABSTRACT

The present disclosure provides an example method for obtaining labeled trajectories. The example method can include obtaining log data describing a trajectory of a vehicle traveling through an environment. The example method can include determining a suboptimal condition associated with the trajectory. The example method can include generating label data that characterizes the suboptimal condition along one or more constraint dimensions of a motion planner of the autonomous vehicle control system. The example method can include generating a training example for training the one or more machine-learned models of the autonomous vehicle control system to decrease a probability of the autonomous vehicle control system inducing the suboptimal condition.

### PRIORITY

This application claims priority to and the benefit of U.S. Provisional Patent Application No. 63/616,297 (filed Dec. 29, 2023). U.S. Provisional Patent Application No. 63/616,297 is hereby incorporated by reference herein in its entirety.

### BACKGROUND

An autonomous platform can process data to perceive an environment through which the autonomous platform travels. For example, an autonomous vehicle can perceive its environment using a variety of sensors and identify objects around the autonomous vehicle. The autonomous vehicle can identify an appropriate path through the perceived surrounding environment and navigate along the path with minimal or no human input.

### SUMMARY

Example implementations of the present disclosure provide for improved training and validation of machine-learned models used for controlling autonomous vehicles. An example evaluation pipeline can process log data descriptive of a trajectory of a vehicle traveling through an environment. The trajectory can be a suboptimal trajectory having one or more parameters (e.g., control or state values) that deviate from a preferred value in the circumstances (e.g., braking more abruptly than desired). A human operator can initiate a corrective action to correct the motion of the vehicle.

This corrective action can be a strong exemplar signal in at least two aspects. In one aspect, the trajectory prior to the corrective action can be an example of a suboptimal trajectory useful for training a machine-learned motion planner based on what not to do. In another aspect the trajectory after the corrective action can be an example of a recovery trajectory useful for training a machine-learned motion planner based on how a human would respond to and recover the vehicle from a suboptimal initial state. The example evaluation pipeline can label the trajectory to not only indicate that the trajectory is suboptimal but also to characterize in what manner the trajectory is suboptimal. For instance, the label data can characterize a suboptimal condition along one or more constraint dimensions used and understood by the motion planner. In this manner, for instance, the label data can give more granular feedback to the machine-learned motion planner to help it learn precisely why certain behaviors are suboptimal.

For example, a suboptimal trajectory can describe an unprotected left turn executed by a vehicle in the presence of oncoming traffic. The suboptimal trajectory can be suboptimal because of the proximity of the oncoming traffic, a speed of the oncoming traffic, or both. Instead of simply training a machine-learned motion planner to not imitate the suboptimal trajectory in general, an example training pipeline according to the present disclosure can add label data that indicates that a particular parameter value of the vehicle state was outside a desired parameter envelope (e.g., too high, too low, etc.). This more specific label data can help the motion planner learn the particular suboptimal features that are not to be imitated.

For example, the label data can be added based on a correction applied by a user during post-processing analysis or by a human operator or controller during operation of the vehicle. The correction can indicate a disagreement between the human and the chosen motion of the vehicle. When the machine-learned motion planner is trained using the suboptimal trajectory, a loss based on the labeled suboptimal trajectory can evaluate an output of the motion planner to determine a similarity with the suboptimal state(s) that led to human correction. In this manner, for instance, the loss can quantify a likelihood that the output of the motion planner would lead to correction and thereby provide a minimization target that trains the motion planner to generate trajectories that are less likely to need correction.

In this manner, for instance, an example training pipeline according to the present disclosure can train machine-learned models to learn operating envelopes in lieu of or in addition to enforcing manually engineered constraints. For example, some traditional motion planning techniques train machine-learned motion planners by applying cost functions that penalize exceeding a predetermined parameter value threshold that was set by an autonomy engineer. But relying on manually set parameter value thresholds can fail to capture the nuances of when that threshold is appropriate or inappropriate for different situations. For instance, while the legal speed limit might be a hard ceiling on an operating speed, there are numerous situations in which the speed limit might be too fast for the particular conditions. Manually setting a threshold speed for infinite variations of difference scenarios is intractable.

Advantageously, then, example training pipelines of the present disclosure can leverage the rich context of log data combined with the strong negative signal of a human corrective action to determine that, for a particular context, a particular vehicle state value is suboptimal. Over large volumes of such labeled training data, example motion planning systems can learn nuanced state value envelopes based on the context of the environment. As such, example training pipelines of the present disclosure can train machine-learned motion planners to achieve better performance than attainable using manually set constraints alone.

Furthermore, example training pipelines of the present disclosure can facilitate holistic evaluation of a given trajectory in context by leveraging human correction information to guide trajectory generation. By evaluating performance holistically against a high-level decision of a human to correct a trajectory, an example training pipeline can evaluate operational models (e.g., a motion planning model) based on the behavior of the vehicle as a predictable and human-like road user. Accordingly, example training pipelines of the present disclosure can assist in more efficient and effective model development by directly training off the ultimate performance outcome—on-road driving behavior—instead of relying solely on engineered constraints as a proxy thereof.

Example training pipelines of the present disclosure can thus improve the performance of a machine-learned model without relying solely on arbitrary hand-tuned thresholds and hard-coded envelopes. For instance, example training pipelines of the present disclosure can leverage the expertise of human drivers. For instance, a human driver might cover the brakes or decrease acceleration when driving past a merging zone of a roadway when there are other vehicles merging into the driver's lane, even though the driver generally has the right of way in the lane. The human driver's choice encodes a complex balancing of risk and cost: the risk of a surprise early cut-in by another vehicle, the cost of being unprepared for the surprise early cut-in, and the cost to the driver of slowing down. If the autonomous vehicle is traveling in a manner that causes the human to correct its behavior (e.g., by disengaging an autonomy system and covering the brakes), this can be a signal that at least one parameter state value was outside a preferred envelope. Accordingly, at scale, the collective behavior of human exemplars can provide a framework for understanding what behavior is expected of vehicles in different driving scenarios and learning nuanced performance envelopes.

As a result of these and other improvements and advancements, for instance, example implementations of the present disclosure can accelerate the adoption of autonomous vehicles, thereby facilitating improved traffic flow, decreasing opportunity for human driver error, increasing energy-efficient driving behavior, etc. across greater numbers of vehicles, thereby achieving not only individual performance gains but also significant population-wide improvement. In this manner, for example, example implementations of the present disclosure can not only improve the functioning of individual autonomous vehicles and their onboard systems but also advance the field of autonomous vehicles and systems as a whole.

For example, in an aspect, the present disclosure provides an example method for obtaining labeled trajectories. The example method can include obtaining log data describing a trajectory of a vehicle traveling through an environment. The example method can include determining a suboptimal condition associated with the trajectory. The example method can include generating label data that characterizes the suboptimal condition along one or more constraint dimensions of a motion planner of the autonomous vehicle control system. The example method can include generating a training example for training the one or more machine-learned models of the autonomous vehicle control system to decrease a probability of the autonomous vehicle control system inducing the suboptimal condition.

In some implementations of the example method, the example method can include determining a corrective action initiated by a human operator of the vehicle, and the vehicle can be an autonomous vehicle. In some implementations of the example method, the human operator can be onboard the autonomous vehicle.

In some implementations of the example method, the example method can include determining the one or more constraint dimensions based on one or more features of the corrective action. In some implementations of the example method, the suboptimal condition can be characterized based on a magnitude of a change in state associated with the corrective action.

In some implementations of the example method, the corrective action can include a braking action or an acceleration action, and the one or more constraint dimensions can correspond to a longitudinal motion parameter. In some implementations of the example method, the corrective action can include a steering action, and the one or more constraint dimensions correspond to a lateral motion parameter.

In some implementations of the example method, the label data can include a direction characteristic that describes a direction of the suboptimality along the one or more constraint dimensions. In some implementations of the example method, the direction characteristic can be determined based on a direction of a corrective action initiated by a human operator.

In some implementations of the example method, determining a suboptimal condition associated with the trajectory can include receiving an annotation from a user device that indicates a preferred trajectory, different from the trajectory from the log data, that a user inputs in association with the log data.

In some implementations of the example method, the example method can include determining the suboptimal portion based on an interval that is associated with the suboptimal condition. In some implementations of the example method, a boundary of the interval can be based on a corrective action initiated by a human operator. In some implementations of the example method, a boundary of the interval can be based on a divergence of a preferred trajectory from the trajectory from the log data, the preferred trajectory obtained from a user input associated with the log data.

In some implementations of the example method, the example method can include selecting the trajectory from the log data based on a score computed for the trajectory.

In some implementations of the example method, the example method can include generating one or more additional training examples from the training example. In some implementations of the example method, the example method can include perturbing a state of a parameter in a direction that increases the suboptimality of the trajectory. The state can include at least one of: (i) a state of the vehicle or (ii) a state of an object in the environment.

In some implementations of the example method, the label data can include: a time interval (e.g., a corrective action start time, a suboptimal interval start time, etc.), a suboptimal state value (e.g., a value of a trajectory parameter associated with the suboptimal condition), and a suboptimality type (e.g., a direction of violation of a constraint).

In some implementations of the example method, the example method can include generating, from the log data, a positive training example for training the machine-learned model to imitate at least a recovery portion of the trajectory, wherein the recovery portion describes the corrective action.

In some implementations of the example method, the suboptimal condition can correspond to a magnitude of first parameter value along a first constraint dimension in combination with a magnitude of a second parameter value along a second constraint dimension. In some implementations of the example method, the label data can characterize the suboptimal condition along a plurality of constraint dimensions joined by one or more Boolean operators.

For example, in an aspect, the present disclosure provides an example computing system for obtaining labeled trajectories. The example computing system can include one or more processors. The example computing system can include one or more non-transitory media storing instructions that are executable by the one or more processors to cause the computing system to perform example operations.

The example operations can include obtaining log data describing a trajectory of a vehicle traveling through an environment. The example operations can include determining a suboptimal condition associated with the trajectory. The example operations can include generating label data that characterizes the suboptimal condition along one or more constraint dimensions of a motion planner of the autonomous vehicle control system. The example operations can include generating a training example for training the one or more machine-learned models of the autonomous vehicle control system to decrease a probability of the autonomous vehicle control system inducing the suboptimal condition.

In some implementations of the example computing system, the example operations can include determining a corrective action initiated by a human operator of the vehicle, and the vehicle can be an autonomous vehicle. In some implementations of the example computing system, the human operator can be onboard the autonomous vehicle.

In some implementations of the example computing system, the example operations can include determining the one or more constraint dimensions based on one or more features of the corrective action. In some implementations of the example computing system, the suboptimal condition can be characterized based on a magnitude of a change in state associated with the corrective action.

In some implementations of the example computing system, the corrective action can include a braking action or an acceleration action, and the one or more constraint dimensions can correspond to a longitudinal motion parameter. In some implementations of the example computing system, the corrective action can include a steering action, and the one or more constraint dimensions correspond to a lateral motion parameter.

In some implementations of the example computing system, the label data can include a direction characteristic that describes a direction of the suboptimality along the one or more constraint dimensions. In some implementations of the example computing system, the direction characteristic can be determined based on a direction of a corrective action initiated by a human operator.

In some implementations of the example computing system, determining a suboptimal condition associated with the trajectory can include receiving an annotation from a user device that indicates a preferred trajectory, different from the trajectory from the log data, that a user inputs in association with the log data.

In some implementations of the example computing system, the example operations can include determining the suboptimal portion based on an interval that is associated with the suboptimal condition. In some implementations of the example computing system, a boundary of the interval can be based on a corrective action initiated by a human operator. In some implementations of the example computing system, a boundary of the interval can be based on a divergence of a preferred trajectory from the trajectory from the log data, the preferred trajectory obtained from a user input associated with the log data.

In some implementations of the example computing system, the example operations can include selecting the trajectory from the log data based on a score computed for the trajectory.

In some implementations of the example computing system, the example operations can include generating one or more additional training examples from the training example. In some implementations of the example computing system, the example operations can include perturbing a state of a parameter in a direction that increases the suboptimality of the trajectory. The state can include at least one of: (i) a state of the vehicle or (ii) a state of an object in the environment.

In some implementations of the example computing system, the label data can include: a time interval (e.g., a corrective action start time, a suboptimal interval start time, etc.), a suboptimal state value (e.g., a value of a trajectory parameter associated with the suboptimal condition), and a suboptimality type (e.g., a direction of violation of a constraint).

In some implementations of the example computing system, the example operations can include generating, from the log data, a positive training example for training the machine-learned model to imitate at least a recovery portion of the trajectory, wherein the recovery portion describes the corrective action.

In some implementations of the example computing system, the suboptimal condition can correspond to a magnitude of first parameter value along a first constraint dimension in combination with a magnitude of a second parameter value along a second constraint dimension. In some implementations of the example computing system, the label data can characterize the suboptimal condition along a plurality of constraint dimensions joined by one or more Boolean operators.

For example, in an aspect, the present disclosure provides an example one or more non-transitory computer-readable media storing instructions that are executable by one or more processors to cause a computing system to perform example operations.

The example operations can include obtaining log data describing a trajectory of a vehicle traveling through an environment. The example operations can include determining a suboptimal condition associated with the trajectory. The example operations can include generating label data that characterizes the suboptimal condition along one or more constraint dimensions of a motion planner of the autonomous vehicle control system. The example operations can include generating a training example for training the one or more machine-learned models of the autonomous vehicle control system to decrease a probability of the autonomous vehicle control system inducing the suboptimal condition.

In some implementations of the example non-transitory computer-readable media, the example operations can include determining a corrective action initiated by a human operator of the vehicle, and the vehicle can be an autonomous vehicle. In some implementations of the example non-transitory computer-readable media, the human operator can be onboard the autonomous vehicle.

In some implementations of the example non-transitory computer-readable media, the example operations can include determining the one or more constraint dimensions based on one or more features of the corrective action. In some implementations of the example non-transitory computer-readable media, the suboptimal condition can be characterized based on a magnitude of a change in state associated with the corrective action.

In some implementations of the example non-transitory computer-readable media, the corrective action can include a braking action or an acceleration action, and the one or more constraint dimensions can correspond to a longitudinal motion parameter. In some implementations of the example non-transitory computer-readable media, the corrective action can include a steering action, and the one or more constraint dimensions correspond to a lateral motion parameter.

In some implementations of the example non-transitory computer-readable media, the label data can include a direction characteristic that describes a direction of the suboptimality along the one or more constraint dimensions. In some implementations of the example non-transitory computer-readable media, the direction characteristic can be determined based on a direction of a corrective action initiated by a human operator.

In some implementations of the example non-transitory computer-readable media, determining a suboptimal condition associated with the trajectory can include receiving an annotation from a user device that indicates a preferred trajectory, different from the trajectory from the log data, that a user inputs in association with the log data.

In some implementations of the example non-transitory computer-readable media, the example operations can include determining the suboptimal portion based on an interval that is associated with the suboptimal condition. In some implementations of the example non-transitory computer-readable media, a boundary of the interval can be based on a corrective action initiated by a human operator. In some implementations of the example non-transitory computer-readable media, a boundary of the interval can be based on a divergence of a preferred trajectory from the trajectory from the log data, the preferred trajectory obtained from a user input associated with the log data.

In some implementations of the example non-transitory computer-readable media, the example operations can include selecting the trajectory from the log data based on a score computed for the trajectory.

In some implementations of the example non-transitory computer-readable media, the example operations can include generating one or more additional training examples from the training example. In some implementations of the example non-transitory computer-readable media, the example operations can include perturbing a state of a parameter in a direction that increases the suboptimality of the trajectory. The state can include at least one of: (i) a state of the vehicle or (ii) a state of an object in the environment.

In some implementations of the example non-transitory computer-readable media, the label data can include: a time interval (e.g., a corrective action start time, a suboptimal interval start time, etc.), a suboptimal state value (e.g., a value of a trajectory parameter associated with the suboptimal condition), and a suboptimality type (e.g., a direction of violation of a constraint).

In some implementations of the example non-transitory computer-readable media, the example operations can include generating, from the log data, a positive training example for training the machine-learned model to imitate at least a recovery portion of the trajectory, wherein the recovery portion describes the corrective action.

In some implementations of the example non-transitory computer-readable media, the suboptimal condition can correspond to a magnitude of first parameter value along a first constraint dimension in combination with a magnitude of a second parameter value along a second constraint dimension. In some implementations of the example non-transitory computer-readable media, the label data can characterize the suboptimal condition along a plurality of constraint dimensions joined by one or more Boolean operators.

Other example aspects of the present disclosure are directed to other systems, methods, vehicles, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 is a block diagram of an example operational scenario, according to some implementations of the present disclosure;

FIG. 2 is a block diagram of an example system, according to some implementations of the present disclosure;

FIG. 3A is a representation of an example operational environment, according to some implementations of the present disclosure;

FIG. 3B is a representation of an example map of an operational environment, according to some implementations of the present disclosure;

FIG. 3C is a representation of an example operational environment, according to some implementations of the present disclosure;

FIG. 3D is a representation of an example map of an operational environment, according to some implementations of the present disclosure;

FIG. 4 is a block diagram of an example system for obtaining training examples, according to some implementations of the present disclosure;

FIG. 5 is an illustration of an example timeline of a training example, according to some implementations of the present disclosure;

FIG. 6A is illustration of a suboptimal trajectory, according to some implementations of the present disclosure;

FIG. 6B is an illustration of trajectory parameters characterizing a suboptimal trajectory, according to some implementations of the present disclosure;

FIG. 7 is a block diagram of a system for using constraint-labeled trajectories to train a machine-learned model, according to some implementations of the present disclosure;

FIG. 8 is a block diagram of a data augmentation system for generating additional training examples, according to some implementations of the present disclosure;

FIG. 9 is an illustration of an example user input interface, according to some implementations of the present disclosure;

FIG. 10 is a flowchart of an example method for obtaining training examples, according to some implementations of the present disclosure;

FIG. 11 is a flowchart of an example method for training a machine-learned model, according to some implementations of the present disclosure;

FIG. 12 is a flowchart of an example method for training and validating a machine-learned operational system, according to some implementations of the present disclosure; and

FIG. 13 is a block diagram of an example computing system for performing system validation, according to some implementations of the present disclosure.

### DETAILED DESCRIPTION

The following describes the technology of this disclosure within the context of an autonomous vehicle for example purposes only. As described herein, the technology described herein is not limited to an autonomous vehicle and can be implemented for or within other autonomous platforms and other computing systems.

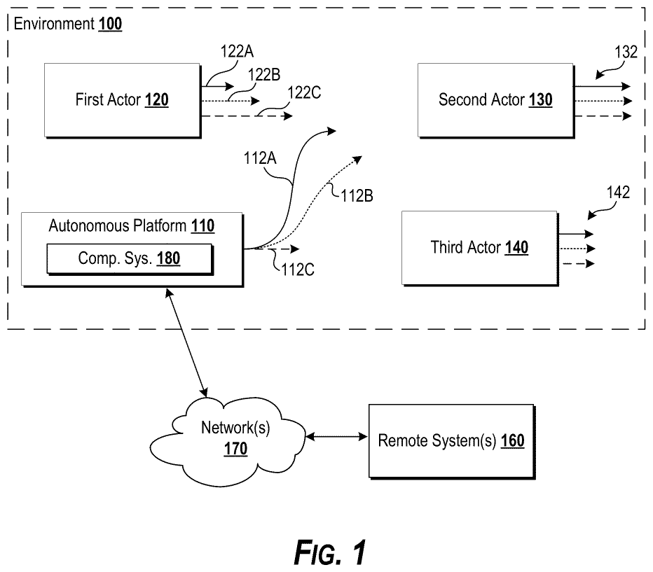

With reference to FIGS. 1-13, example implementations of the present disclosure are discussed in further detail. FIG. 1 is a block diagram of an example operational scenario, according to some implementations of the present disclosure. In the example operational scenario, an environment 100 contains an autonomous platform 110 and a number of objects, including first actor 120, second actor 130, and third actor 140. In the example operational scenario, the autonomous platform 110 can move through the environment 100 and interact with the object(s) that are located within the environment 100 (e.g., first actor 120, second actor 130, third actor 140, etc.). The autonomous platform 110 can optionally be configured to communicate with remote system(s) 160 through network(s) 170.

The environment 100 may be or include an indoor environment (e.g., within one or more facilities, etc.) or an outdoor environment. An indoor environment, for example, may be an environment enclosed by a structure such as a building (e.g., a service depot, maintenance location, manufacturing facility, etc.). An outdoor environment, for example, may be one or more areas in the outside world such as, for example, one or more rural areas (e.g., with one or more rural travel ways, etc.), one or more urban areas (e.g., with one or more city travel ways, highways, etc.), one or more suburban areas (e.g., with one or more suburban travel ways, etc.), or other outdoor environments.

The autonomous platform 110 may be any type of platform configured to operate within the environment 100. For example, the autonomous platform 110 may be a vehicle configured to autonomously perceive and operate within the environment 100. The vehicles may be a ground-based autonomous vehicle such as, for example, an autonomous car, truck, van, etc. The autonomous platform 110 may be an autonomous vehicle that can control, be connected to, or be otherwise associated with implements, attachments, and/or accessories for transporting people or cargo. This can include, for example, an autonomous tractor optionally coupled to a cargo trailer. Additionally, or alternatively, the autonomous platform 110 may be any other type of vehicle such as one or more aerial vehicles, water-based vehicles, space-based vehicles, other ground-based vehicles, etc.

The autonomous platform 110 may be configured to communicate with the remote system(s) 160. For instance, the remote system(s) 160 can communicate with the autonomous platform 110 for assistance (e.g., navigation assistance, situation response assistance, etc.), control (e.g., fleet management, remote operation, etc.), maintenance (e.g., updates, monitoring, etc.), or other local or remote tasks. In some implementations, the remote system(s) 160 can provide data indicating tasks that the autonomous platform 110 should perform. For example, as further described herein, the remote system(s) 160 can provide data indicating that the autonomous platform 110 is to perform a trip/service such as a user transportation trip/service, delivery trip/service (e.g., for cargo, freight, items), etc.

The autonomous platform 110 can communicate with the remote system(s) 160 using the network(s) 170. The network(s) 170 can facilitate the transmission of signals (e.g., electronic signals, etc.) or data (e.g., data from a computing device, etc.) and can include any combination of various wired (e.g., twisted pair cable, etc.) or wireless communication mechanisms (e.g., cellular, wireless, satellite, microwave, radio frequency, etc.) or any desired network topology (or topologies). For example, the network(s) 170 can include a local area network (e.g., intranet, etc.), a wide area network (e.g., the Internet, etc.), a wireless LAN network (e.g., through Wi-Fi, etc.), a cellular network, a SATCOM network, a VHF network, a HF network, a WiMAX based network, or any other suitable communications network (or combination thereof) for transmitting data to or from the autonomous platform 110.

As shown for example in FIG. 1, environment 100 can include one or more objects. The object(s) may be objects not in motion or not predicted to move (“static objects”) or object(s) in motion or predicted to be in motion (“dynamic objects” or “actors”). In some implementations, the environment 100 can include any number of actor(s) such as, for example, one or more pedestrians, animals, vehicles, etc. The actor(s) can move within the environment according to one or more actor trajectories. For instance, the first actor 120 can move along any one of the first actor trajectories 122A-C, the second actor 130 can move along any one of the second actor trajectories 132, the third actor 140 can move along any one of the third actor trajectories 142, etc.

As further described herein, the autonomous platform 110 can utilize its autonomy system(s) to detect these actors (and their movement) and plan its motion to navigate through the environment 100 according to one or more platform trajectories 112A-C. The autonomous platform 110 can include onboard computing system(s) 180. The onboard computing system(s) 180 can include one or more processors and one or more memory devices. The one or more memory devices can store instructions executable by the one or more processors to cause the one or more processors to perform operations or functions associated with the autonomous platform 110, including implementing its autonomy system(s).

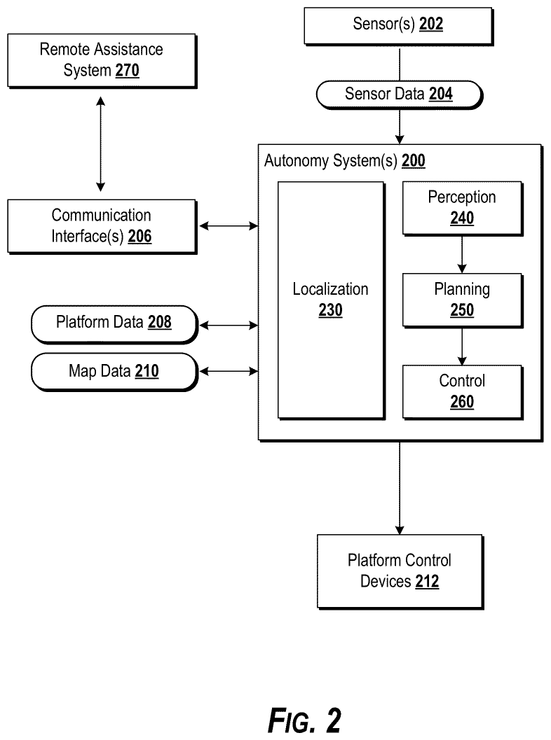

FIG. 2 is a block diagram of an example autonomy system 200 for an autonomous platform, according to some implementations of the present disclosure. In some implementations, the autonomy system 200 can be implemented by a computing system of the autonomous platform (e.g., the onboard computing system(s) 180 of the autonomous platform 110). The autonomy system 200 can operate to obtain inputs from sensor(s) 202 or other input devices. In some implementations, the autonomy system 200 can additionally obtain platform data 208 (e.g., map data 210) from local or remote storage. The autonomy system 200 can generate control outputs for controlling the autonomous platform (e.g., through platform control devices 212, etc.) based on sensor data 204, map data 210, or other data. The autonomy system 200 may include different subsystems for performing various autonomy operations. The subsystems may include a localization system 230, a perception system 240, a planning system 250, and a control system 260. The localization system 230 can determine the location of the autonomous platform within its environment; the perception system 240 can detect, classify, and track objects and actors in the environment; the planning system 250 can determine a trajectory for the autonomous platform; and the control system 260 can translate the trajectory into vehicle controls for controlling the autonomous platform. The autonomy system 200 can be implemented by one or more onboard computing system(s). The subsystems can include one or more processors and one or more memory devices. The one or more memory devices can store instructions executable by the one or more processors to cause the one or more processors to perform operations or functions associated with the subsystems. The computing resources of the autonomy system 200 can be shared among its subsystems, or a subsystem can have a set of dedicated computing resources.

In some implementations, the autonomy system 200 can be implemented for or by an autonomous vehicle (e.g., a ground-based autonomous vehicle). The autonomy system 200 can perform various processing techniques on inputs (e.g., the sensor data 204, the map data 210) to perceive and understand the vehicle's surrounding environment and generate an appropriate set of control outputs to implement a vehicle motion plan (e.g., including one or more trajectories) for traversing the vehicle's surrounding environment (e.g., environment 100 of FIG. 1, etc.). In some implementations, an autonomous vehicle implementing the autonomy system 200 can drive, navigate, operate, etc. with minimal or no interaction from a human operator (e.g., driver, pilot, etc.).

In some implementations, the autonomous platform can be configured to operate in a plurality of operating modes. For instance, the autonomous platform can be configured to operate in a fully autonomous (e.g., self-driving, etc.) operating mode in which the autonomous platform is controllable without user input (e.g., can drive and navigate with no input from a human operator present in the autonomous vehicle or remote from the autonomous vehicle, etc.). The autonomous platform can operate in a semi-autonomous operating mode in which the autonomous platform can operate with some input from a human operator present in the autonomous platform (or a human operator that is remote from the autonomous platform). In some implementations, the autonomous platform can enter into a manual operating mode in which the autonomous platform is fully controllable by a human operator (e.g., human driver, etc.) and can be prohibited or disabled (e.g., temporary, permanently, etc.) from performing autonomous navigation (e.g., autonomous driving, etc.). The autonomous platform can be configured to operate in other modes such as, for example, park or sleep modes (e.g., for use between tasks such as waiting to provide a trip/service, recharging, etc.). In some implementations, the autonomous platform can implement vehicle operating assistance technology (e.g., collision mitigation system, power assist steering, etc.), for example, to help assist the human operator of the autonomous platform (e.g., while in a manual mode, etc.).

Autonomy system 200 can be located onboard (e.g., on or within) an autonomous platform and can be configured to operate the autonomous platform in various environments. The environment may be a real-world environment or a simulated environment. In some implementations, one or more simulation computing devices can simulate one or more of: the sensors 202, the sensor data 204, communication interface(s) 206, the platform data 208, or the platform control devices 212 for simulating operation of the autonomy system 200.

In some implementations, the autonomy system 200 can communicate with one or more networks or other systems with the communication interface(s) 206. The communication interface(s) 206 can include any suitable components for interfacing with one or more network(s) (e.g., the network(s) 170 of FIG. 1, etc.), including, for example, transmitters, receivers, ports, controllers, antennas, or other suitable components that can help facilitate communication. In some implementations, the communication interface(s) 206 can include a plurality of components (e.g., antennas, transmitters, or receivers, etc.) that allow it to implement and utilize various communication techniques (e.g., multiple-input, multiple-output (MIMO) technology, etc.).

In some implementations, the autonomy system 200 can use the communication interface(s) 206 to communicate with one or more computing devices that are remote from the autonomous platform (e.g., the remote system(s) 160) over one or more network(s) (e.g., the network(s) 170). For instance, in some examples, one or more inputs, data, or functionalities of the autonomy system 200 can be supplemented or substituted by a remote system communicating over the communication interface(s) 206. For instance, in some implementations, the map data 210 can be downloaded over a network to a remote system using the communication interface(s) 206. In some examples, one or more of localization system 230, perception system 240, planning system 250, or control system 260 can be updated, influenced, nudged, communicated with, etc. by a remote system for assistance, maintenance, situational response override, management, etc.

The sensor(s) 202 can be located onboard the autonomous platform. In some implementations, the sensor(s) 202 can include one or more types of sensor(s). For instance, one or more sensors can include image capturing device(s) (e.g., visible spectrum cameras, infrared cameras, etc.). Additionally, or alternatively, the sensor(s) 202 can include one or more depth capturing device(s). For example, the sensor(s) 202 can include one or more Light Detection and Ranging (LIDAR) sensor(s) or Radio Detection and Ranging (RADAR) sensor(s). The sensor(s) 202 can be configured to generate point data descriptive of at least a portion of a three-hundred-and-sixty-degree view of the surrounding environment. The point data can be point cloud data (e.g., three-dimensional LIDAR point cloud data, RADAR point cloud data). In some implementations, one or more of the sensor(s) 202 for capturing depth information can be fixed to a rotational device in order to rotate the sensor(s) 202 about an axis. The sensor(s) 202 can be rotated about the axis while capturing data in interval sector packets descriptive of different portions of a three-hundred-and-sixty-degree view of a surrounding environment of the autonomous platform. In some implementations, one or more of the sensor(s) 202 for capturing depth information can be solid state.

The sensor(s) 202 can be configured to capture the sensor data 204 indicating or otherwise being associated with at least a portion of the environment of the autonomous platform. The sensor data 204 can include image data (e.g., 2D camera data, video data, etc.), RADAR data, LIDAR data (e.g., 3D point cloud data, etc.), audio data, or other types of data. In some implementations, the autonomy system 200 can obtain input from additional types of sensors, such as inertial measurement units (IMUs), altimeters, inclinometers, odometry devices, location or positioning devices (e.g., GPS, compass), wheel encoders, or other types of sensors. In some implementations, the autonomy system 200 can obtain sensor data 204 associated with particular component(s) or system(s) of an autonomous platform. This sensor data 204 can indicate, for example, wheel speed, component temperatures, steering angle, cargo or passenger status, etc. In some implementations, the autonomy system 200 can obtain sensor data 204 associated with ambient conditions, such as environmental or weather conditions. In some implementations, the sensor data 204 can include multi-modal sensor data. The multi-modal sensor data can be obtained by at least two different types of sensor(s) (e.g., of the sensors 202) and can indicate static object(s) or actor(s) within an environment of the autonomous platform. The multi-modal sensor data can include at least two types of sensor data (e.g., camera and LIDAR data). In some implementations, the autonomous platform can utilize the sensor data 204 for sensors that are remote from (e.g., offboard) the autonomous platform. This can include for example, sensor data 204 captured by a different autonomous platform.

The autonomy system 200 can obtain the map data 210 associated with an environment in which the autonomous platform was, is, or will be located. The map data 210 can provide information about an environment or a geographic area. For example, the map data 210 can provide information regarding the identity and location of different travel ways (e.g., roadways, etc.), travel way segments (e.g., road segments, etc.), buildings, or other items or objects (e.g., lampposts, crosswalks, curbs, etc.); the location and directions of boundaries or boundary markings (e.g., the location and direction of traffic lanes, parking lanes, turning lanes, bicycle lanes, other lanes, etc.); traffic control data (e.g., the location and instructions of signage, traffic lights, other traffic control devices, etc.); obstruction information (e.g., temporary or permanent blockages, etc.); event data (e.g., road closures/traffic rule alterations due to parades, concerts, sporting events, etc.); nominal vehicle path data (e.g., indicating an ideal vehicle path such as along the center of a certain lane, etc.); or any other map data that provides information that assists an autonomous platform in understanding its surrounding environment and its relationship thereto. In some implementations, the map data 210 can include high-definition map information. Additionally, or alternatively, the map data 210 can include sparse map data (e.g., lane graphs, etc.). In some implementations, the sensor data 204 can be fused with or used to update the map data 210 in real-time.

The autonomy system 200 can include the localization system 230, which can provide an autonomous platform with an understanding of its location and orientation in an environment. In some examples, the localization system 230 can support one or more other subsystems of the autonomy system 200, such as by providing a unified local reference frame for performing, e.g., perception operations, planning operations, or control operations.

In some implementations, the localization system 230 can determine a current position of the autonomous platform. A current position can include a global position (e.g., respecting a georeferenced anchor, etc.) or relative position (e.g., respecting objects in the environment, etc.). The localization system 230 can generally include or interface with any device or circuitry for analyzing a position or change in position of an autonomous platform (e.g., autonomous ground-based vehicle, etc.). For example, the localization system 230 can determine position by using one or more of: inertial sensors (e.g., inertial measurement unit(s), etc.), a satellite positioning system, radio receivers, networking devices (e.g., based on IP address, etc.), triangulation or proximity to network access points or other network components (e.g., cellular towers, Wi-Fi access points, etc.), or other suitable techniques. The position of the autonomous platform can be used by various subsystems of the autonomy system 200 or provided to a remote computing system (e.g., using the communication interface(s) 206).

In some implementations, the localization system 230 can register relative positions of elements of a surrounding environment of an autonomous platform with recorded positions in the map data 210. For instance, the localization system 230 can process the sensor data 204 (e.g., LIDAR data, RADAR data, camera data, etc.) for aligning or otherwise registering to a map of the surrounding environment (e.g., from the map data 210) to understand the autonomous platform's position within that environment. Accordingly, in some implementations, the autonomous platform can identify its position within the surrounding environment (e.g., across six axes, etc.) based on a search over the map data 210. In some implementations, given an initial location, the localization system 230 can update the autonomous platform's location with incremental re-alignment based on recorded or estimated deviations from the initial location. In some implementations, a position can be registered directly within the map data 210.

In some implementations, the map data 210 can include a large volume of data subdivided into geographic tiles, such that a desired region of a map stored in the map data 210 can be reconstructed from one or more tiles. For instance, a plurality of tiles selected from the map data 210 can be stitched together by the autonomy system 200 based on a position obtained by the localization system 230 (e.g., a number of tiles selected in the vicinity of the position).

In some implementations, the localization system 230 can determine positions (e.g., relative or absolute) of one or more attachments or accessories for an autonomous platform. For instance, an autonomous platform can be associated with a cargo platform, and the localization system 230 can provide positions of one or more points on the cargo platform. For example, a cargo platform can include a trailer or other device towed or otherwise attached to or manipulated by an autonomous platform, and the localization system 230 can provide for data describing the position (e.g., absolute, relative, etc.) of the autonomous platform as well as the cargo platform. Such information can be obtained by the other autonomy systems to help operate the autonomous platform.

The autonomy system 200 can include the perception system 240, which can allow an autonomous platform to detect, classify, and track objects and actors in its environment. Environmental features or objects perceived within an environment can be those within the field of view of the sensor(s) 202 or predicted to be occluded from the sensor(s) 202. This can include object(s) not in motion or not predicted to move (static objects) or object(s) in motion or predicted to be in motion (dynamic objects/actors).

The perception system 240 can determine one or more states (e.g., current or past state(s), etc.) of one or more objects that are within a surrounding environment of an autonomous platform. For example, state(s) can describe (e.g., for a given time, time period, etc.) an estimate of an object's current or past location (also referred to as position); current or past speed/velocity; current or past acceleration; current or past heading; current or past orientation; size/footprint (e.g., as represented by a bounding shape, object highlighting, etc.); classification (e.g., pedestrian class vs. vehicle class vs. bicycle class, etc.); the uncertainties associated therewith; or other state information. In some implementations, the perception system 240 can determine the state(s) using one or more algorithms or machine-learned models configured to identify/classify objects based on inputs from the sensor(s) 202. The perception system can use different modalities of the sensor data 204 to generate a representation of the environment to be processed by the one or more algorithms or machine-learned models. In some implementations, state(s) for one or more identified or unidentified objects can be maintained and updated over time as the autonomous platform continues to perceive or interact with the objects (e.g., maneuver with or around, yield to, etc.). In this manner, the perception system 240 can provide an understanding about a current state of an environment (e.g., including the objects therein, etc.) informed by a record of prior states of the environment (e.g., including movement histories for the objects therein). Such information can be helpful as the autonomous platform plans its motion through the environment.

The autonomy system 200 can include the planning system 250, which can be configured to determine how the autonomous platform is to interact with and move within its environment. The planning system 250 can determine one or more motion plans for an autonomous platform. A motion plan can include one or more trajectories (e.g., motion trajectories) that indicate a path for an autonomous platform to follow. A trajectory can be of a certain length or time range. The length or time range can be defined by the computational planning horizon of the planning system 250. A motion trajectory can be defined by one or more waypoints (with associated coordinates). The waypoint(s) can be future location(s) for the autonomous platform. The motion plans can be continuously generated, updated, and considered by the planning system 250.

The motion planning system 250 can determine a strategy for the autonomous platform. A strategy may be a set of discrete decisions (e.g., yield to actor, reverse yield to actor, merge, lane change) that the autonomous platform makes. The strategy may be selected from a plurality of potential strategies. The selected strategy may be a lowest cost strategy as determined by one or more cost functions. The cost functions may, for example, evaluate the probability of a collision with another actor or object.

The planning system 250 can determine a desired trajectory for executing a strategy. For instance, the planning system 250 can obtain one or more trajectories for executing one or more strategies. The planning system 250 can evaluate trajectories or strategies (e.g., with scores, costs, rewards, constraints, etc.) and rank them. For instance, the planning system 250 can use forecasting output(s) that indicate interactions (e.g., proximity, intersections, etc.) between trajectories for the autonomous platform and one or more objects to inform the evaluation of candidate trajectories or strategies for the autonomous platform. In some implementations, the planning system 250 can utilize static cost(s) to evaluate trajectories for the autonomous platform (e.g., “avoid lane boundaries,” “minimize jerk,” etc.). Additionally, or alternatively, the planning system 250 can utilize dynamic cost(s) to evaluate the trajectories or strategies for the autonomous platform based on forecasted outcomes for the current operational scenario (e.g., forecasted trajectories or strategies leading to interactions between actors, forecasted trajectories or strategies leading to interactions between actors and the autonomous platform, etc.). The planning system 250 can rank trajectories based on one or more static costs, one or more dynamic costs, or a combination thereof. The planning system 250 can select a motion plan (and a corresponding trajectory) based on a ranking of a plurality of candidate trajectories. In some implementations, the planning system 250 can select a highest ranked candidate, or a highest ranked feasible candidate.

The planning system 250 can then validate the selected trajectory against one or more constraints before the trajectory is executed by the autonomous platform.

To help with its motion planning decisions, the planning system 250 can be configured to perform a forecasting function. The planning system 250 can forecast future state(s) of the environment. This can include forecasting the future state(s) of other actors in the environment. In some implementations, the planning system 250 can forecast future state(s) based on current or past state(s) (e.g., as developed or maintained by the perception system 240). In some implementations, future state(s) can be or include forecasted trajectories (e.g., positions over time) of the objects in the environment, such as other actors. In some implementations, one or more of the future state(s) can include one or more probabilities associated therewith (e.g., marginal probabilities, conditional probabilities). For example, the one or more probabilities can include one or more probabilities conditioned on the strategy or trajectory options available to the autonomous platform. Additionally, or alternatively, the probabilities can include probabilities conditioned on trajectory options available to one or more other actors.

In some implementations, the planning system 250 can perform interactive forecasting. The planning system 250 can determine a motion plan for an autonomous platform with an understanding of how forecasted future states of the environment can be affected by execution of one or more candidate motion plans. By way of example, with reference again to FIG. 1, the autonomous platform 110 can determine candidate motion plans corresponding to a set of platform trajectories 112A-C that respectively correspond to the first actor trajectories 122A-C for the first actor 120, trajectories 132 for the second actor 130, and trajectories 142 for the third actor 140 (e.g., with respective trajectory correspondence indicated with matching line styles). For instance, the autonomous platform 110 (e.g., using its autonomy system 200) can forecast that a platform trajectory 112A to more quickly move the autonomous platform 110 into the area in front of the first actor 120 is likely associated with the first actor 120 decreasing forward speed and yielding more quickly to the autonomous platform 110 in accordance with first actor trajectory 122A. Additionally or alternatively, the autonomous platform 110 can forecast that a platform trajectory 112B to gently move the autonomous platform 110 into the area in front of the first actor 120 is likely associated with the first actor 120 slightly decreasing speed and yielding slowly to the autonomous platform 110 in accordance with first actor trajectory 122B. Additionally or alternatively, the autonomous platform 110 can forecast that a platform trajectory 112C to remain in a parallel alignment with the first actor 120 is likely associated with the first actor 120 not yielding any distance to the autonomous platform 110 in accordance with first actor trajectory 122C. Based on comparison of the forecasted scenarios to a set of desired outcomes (e.g., by scoring scenarios based on a cost or reward), the planning system 250 can select a motion plan (and its associated trajectory) in view of the autonomous platform's interaction with the environment 100. In this manner, for example, the autonomous platform 110 can interleave its forecasting and motion planning functionality.

To implement selected motion plan(s), the autonomy system 200 can include a control system 260 (e.g., a vehicle control system). Generally, the control system 260 can provide an interface between the autonomy system 200 and the platform control devices 212 for implementing the strategies and motion plan(s) generated by the planning system 250. For instance, control system 260 can implement the selected motion plan/trajectory to control the autonomous platform's motion through its environment by following the selected trajectory (e.g., the waypoints included therein). The control system 260 can, for example, translate a motion plan into instructions for the appropriate platform control devices 212 (e.g., acceleration control, brake control, steering control, etc.). By way of example, the control system 260 can translate a selected motion plan into instructions to adjust a steering component (e.g., a steering angle) by a certain number of degrees, apply a certain magnitude of braking force, increase/decrease speed, etc. In some implementations, the control system 260 can communicate with the platform control devices 212 through communication channels including, for example, one or more data buses (e.g., controller area network (CAN), etc.), onboard diagnostics connectors (e.g., OBD-II, etc.), or a combination of wired or wireless communication links. The platform control devices 212 can send or obtain data, messages, signals, etc. to or from the autonomy system 200 (or vice versa) through the communication channel(s).

The autonomy system 200 can receive, through communication interface(s) 206, assistive signal(s) from remote assistance system 270. Remote assistance system 270 can communicate with the autonomy system 200 over a network (e.g., as a remote system 160 over network 170). In some implementations, the autonomy system 200 can initiate a communication session with the remote assistance system 270. For example, the autonomy system 200 can initiate a session based on or in response to a trigger. In some implementations, the trigger may be an alert, an error signal, a map feature, a request, a location, a traffic condition, a road condition, etc.

After initiating the session, the autonomy system 200 can provide context data to the remote assistance system 270. The context data may include sensor data 204 and state data of the autonomous platform. For example, the context data may include a live camera feed from a camera of the autonomous platform and the autonomous platform's current speed. A user of the remote assistance system 270 can use the context data to select assistive signals. The assistive signal(s) can provide values or adjustments for various operational parameters or characteristics for the autonomy system 200. For instance, the assistive signal(s) can include way points (e.g., a path around an obstacle, lane change, etc.), velocity or acceleration profiles (e.g., speed limits, etc.), relative motion instructions (e.g., convoy formation, etc.), operational characteristics (e.g., use of auxiliary systems, reduced energy processing modes, etc.), or other signals to assist the autonomy system 200.

Autonomy system 200 can use the assistive signal(s) for input into one or more autonomy subsystems for performing autonomy functions. For instance, the planning subsystem 250 can receive the assistive signal(s) as an input for generating a motion plan. For example, assistive signal(s) can include constraints for generating a motion plan. Additionally, or alternatively, assistive signal(s) can include cost or reward adjustments for influencing motion planning by the planning subsystem 250. Additionally, or alternatively, assistive signal(s) can be considered by the autonomy system 200 as suggestive inputs for consideration in addition to other received data (e.g., sensor inputs, etc.).

The autonomy system 200 may be platform agnostic, and the control system 260 can provide control instructions to platform control devices 212 for a variety of different platforms for autonomous movement (e.g., a plurality of different autonomous platforms fitted with autonomous control systems). This can include a variety of different types of autonomous vehicles (e.g., sedans, vans, SUVs, trucks, electric vehicles, combustion power vehicles, etc.) from a variety of different manufacturers/developers that operate in various different environments and, in some implementations, perform one or more vehicle services.

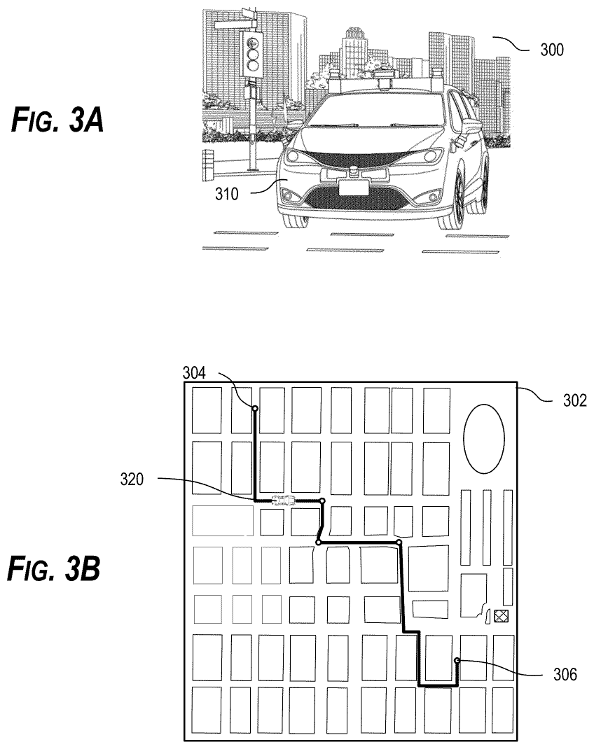

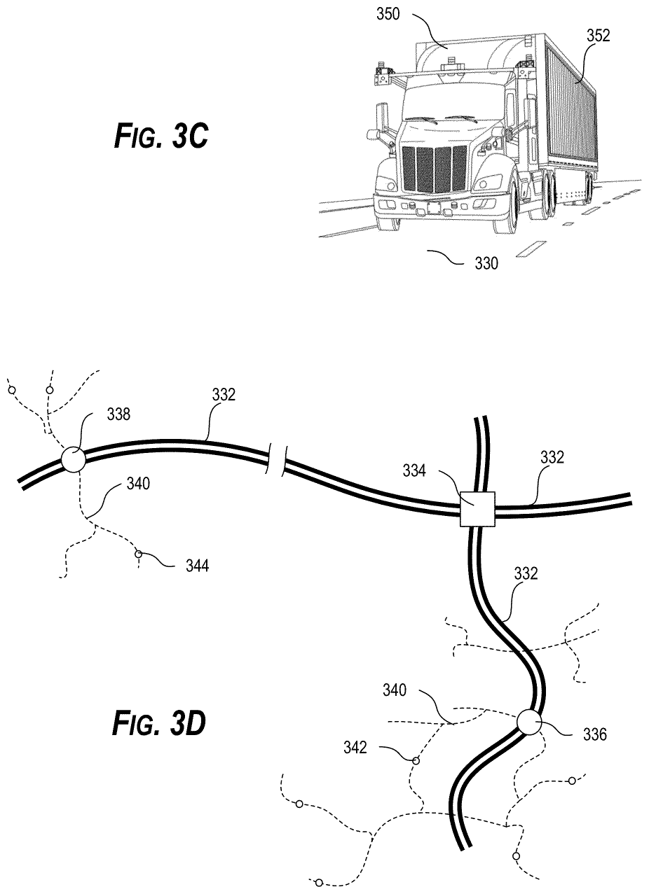

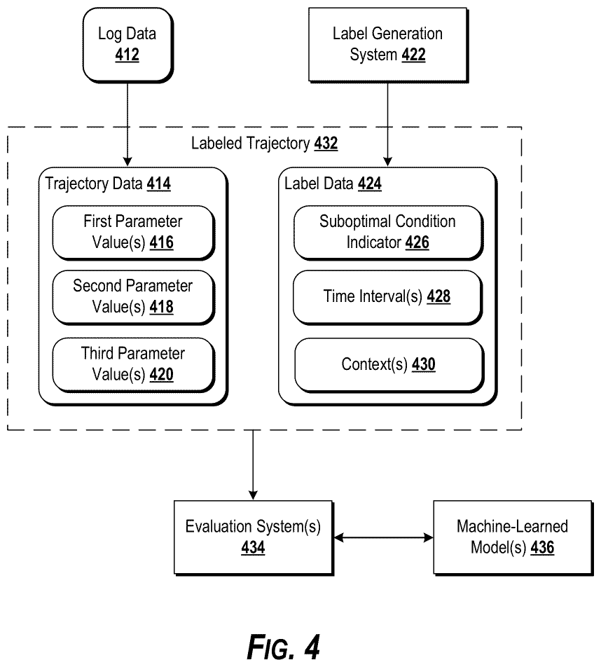

For example, with reference to FIG. 3A, an operational environment can include a dense environment 300. An autonomous platform can include an autonomous vehicle 310 controlled by the autonomy system 200. In some implementations, the autonomous vehicle 310 can be configured for maneuverability in a dense environment, such as with a configured wheelbase or other specifications. In some implementations, the autonomous vehicle 310 can be configured for transporting cargo or passengers. In some implementations, the autonomous vehicle 310 can be configured to transport numerous passengers (e.g., a passenger van, a shuttle, a bus, etc.). In some implementations, the autonomous vehicle 310 can be configured to transport cargo, such as large quantities of cargo (e.g., a truck, a box van, a step van, etc.) or smaller cargo (e.g., food, personal packages, etc.).

With reference to FIG. 3B, a selected overhead view 302 of the dense environment 300 is shown overlaid with an example trip/service between a first location 304 and a second location 306. The example trip/service can be assigned, for example, to an autonomous vehicle 320 by a remote computing system. The autonomous vehicle 320 can be, for example, the same type of vehicle as autonomous vehicle 310. The example trip/service can include transporting passengers or cargo between the first location 304 and the second location 306. In some implementations, the example trip/service can include travel to or through one or more intermediate locations, such as to onload or offload passengers or cargo. In some implementations, the example trip/service can be prescheduled (e.g., for regular traversal, such as on a transportation schedule). In some implementations, the example trip/service can be on-demand (e.g., as requested by or for performing a taxi, rideshare, ride hailing, courier, delivery service, etc.).

With reference to FIG. 3C, in another example, an operational environment can include an open travel way environment 330. An autonomous platform can include an autonomous vehicle 350 controlled by the autonomy system 200. This can include an autonomous tractor for an autonomous truck. In some implementations, the autonomous vehicle 350 can be configured for high payload transport (e.g., transporting freight or other cargo or passengers in quantity), such as for long distance, high payload transport. For instance, the autonomous vehicle 350 can include one or more cargo platform attachments such as a trailer 352. Although depicted as a towed attachment in FIG. 3C, in some implementations one or more cargo platforms can be integrated into (e.g., attached to the chassis of, etc.) the autonomous vehicle 350 (e.g., as in a box van, step van, etc.).

With reference to FIG. 3D, a selected overhead view of open travel way environment 330 is shown, including travel ways 332, an interchange 334, transfer hubs 336 and 338, access travel ways 340, and locations 342 and 344. In some implementations, an autonomous vehicle (e.g., the autonomous vehicle 310 or the autonomous vehicle 350) can be assigned an example trip/service to traverse the one or more travel ways 332 (optionally connected by the interchange 334) to transport cargo between the transfer hub 336 and the transfer hub 338. For instance, in some implementations, the example trip/service includes a cargo delivery/transport service, such as a freight delivery/transport service. The example trip/service can be assigned by a remote computing system. In some implementations, the transfer hub 336 can be an origin point for cargo (e.g., a depot, a warehouse, a facility, etc.) and the transfer hub 338 can be a destination point for cargo (e.g., a retailer, etc.). However, in some implementations, the transfer hub 336 can be an intermediate point along a cargo item's ultimate journey between its respective origin and its respective destination. For instance, a cargo item's origin can be situated along the access travel ways 340 at the location 342. The cargo item can accordingly be transported to transfer hub 336 (e.g., by a human-driven vehicle, by the autonomous vehicle 310, etc.) for staging. At the transfer hub 336, various cargo items can be grouped or staged for longer distance transport over the travel ways 332.

In some implementations of an example trip/service, a group of staged cargo items can be loaded onto an autonomous vehicle (e.g., the autonomous vehicle 350) for transport to one or more other transfer hubs, such as the transfer hub 338. For instance, although not depicted, it is to be understood that the open travel way environment 330 can include more transfer hubs than the transfer hubs 336 and 338 and can include more travel ways 332 interconnected by more interchanges 334. A simplified map is presented here for purposes of clarity only. In some implementations, one or more cargo items transported to the transfer hub 338 can be distributed to one or more local destinations (e.g., by a human-driven vehicle, by the autonomous vehicle 310, etc.), such as along the access travel ways 340 to the location 344. In some implementations, the example trip/service can be prescheduled (e.g., for regular traversal, such as on a transportation schedule). In some implementations, the example trip/service can be on-demand (e.g., as requested by or for performing a chartered passenger transport or freight delivery service).

To improve the performance of an autonomous platform, such as an autonomous vehicle controlled at least in part using autonomy system 200 (e.g., the autonomous vehicles 310 or 350), a system can generate labeled trajectories for machine-learned model training and evaluation according to some implementations of the present disclosure.

In general, training or validating an autonomy system 200 (or component(s) thereof, such as a planning system 250) can rely on knowledge of what behavior is preferred and what behavior is not preferred. Evaluation of trajectories generated by a motion planning system can use a decision boundary (explicitly or implicitly). The decision boundary can separate trajectories associated with positive evaluation from trajectories associated with negative evaluation. For instance, in a validation context, a motion planning system that generates trajectories outside the decision boundary can be queued for further training or improvement. In a training context, generated outputs that fall outside the decision boundary can be penalized, and the motion planning system can be updated to reduce a likelihood of generating further outputs that fall outside the decision boundary.

Prescriptively identifying what is preferred behavior for a given driving scenario can be a complex endeavor. Instead of attempting to a priori enumerate a list of appropriate constraints for all possible scenarios, a system can learn a decision boundary by observing human exemplar drivers. Human drivers can be very good at quickly understanding a given driving scenario and determining what actions are appropriate for the circumstances. These in-situ decisions can encode complex balancing of risk, cost, and shared expectations based on general traffic customs. As such, an envelope of preferred driving characteristics can be learned from actions taken by human drivers (e.g., as “expert” exemplars).

For example, corrective actions undertaken by human operators to correct a motion of a vehicle can provide especially strong signals regarding the boundaries of the envelope of preferred driving characteristics. For example, an exemplar trajectory in which a human driver proceeds at a constant speed in a lane on an otherwise empty freeway might provide an example of known good behavior but might not illuminate where the boundary between good and suboptimal behavior lies. In contrast, an exemplar trajectory in which a human operator of an autonomous vehicle disengages an autonomy system (e.g., autonomy system 200) to take control of the vehicle and implement a corrective action can be interpreted as a signal that the behavior of the vehicle at some time changed from acceptable to suboptimal, prompting the human operator to take over. This change, indicated by the takeover/disengagement, can provide information describing a boundary of an envelope of preferred driving characteristics, with the trajectory crossing the boundary at a time corresponding to the disengagement. When observed over a corpus of examples of trajectories of suboptimal behavior, the shape of the envelope along many different dimensions can be refined.

To refine the contour of the envelope, it can be helpful to identify precisely what was suboptimal about a given trajectory. This can help identify a direction in which the decision boundary was crossed (or should have been crossed), thus informing what aspects of the envelope can be updated/refined using the particular trajectory. Example implementations of the present disclosure thus provide for obtaining “constraint labels” which can not only identify suboptimal driving behaviors but also identify the aspects in which the behavior is suboptimal.

The aspects in which the behavior is suboptimal can be associated with one or more “constraint dimensions.” For example, a decision boundary can be represented by a surface or hyperplane in a parameterization space that parameterizes trajectories generated by the motion planning system. For instance, a trajectory can be characterized by a speed, acceleration, control input states, etc. The decision boundary can represent, for a given combination of parameter values, a limit after which any further change in a parameter value along that parameter's dimension would result in a suboptimal condition. In this manner, for instance, the decision boundary can provide constraints on each dimension of the parameterization space.

In this manner, for instance, constraint labels can identify where a boundary should be along a particular constraint dimension in a particular context. For example, for example, a trajectory can be identified as “too fast for the conditions.” This statement distills the complexity of evaluating speed and context by identifying a single constraint dimension along which the trajectory is suboptimal (a dimension associated with speed) and the direction in which it was suboptimal (too high). This label can signal that when traversing the path of that trajectory with respect to objects in the scene, or even more generally, in scenarios similar to the conditions of that labeled trajectory, the constraint on speed should be lower than the speed of that trajectory.

In general, comparison against a constraint value along a constraint dimension can provide an interpretable heuristic for evaluating whether a particular parameter value is appropriate. A constraint dimension can be based on multiple different parameters together. For example, one parameter can correspond to velocity. Another parameter can correspond to a steering angle. While each of velocity and steering angle can be associated with individual constraint dimensions (e.g., indicating acceptable ranges for each), there can also be a constraint dimension for some combination thereof (e.g., a speed-weighted steering angle) that provides a heuristic to determine whether too much steering angle is used at too high a speed.

Constraints can include limits on position (e.g., with respect to map elements, with respect to environmental elements, with respect to other actors, etc.), velocity (lateral, longitudinal, rotational, etc.), acceleration (lateral, longitudinal, rotational, etc.), jerk, or other dynamic properties of motion. These constraints can define acceptable behavior for a vehicle while it navigates through its environment.

Constraints can include various different limits on a vehicle's speed, such as maximum or minimum speeds, or preferred speeds under specific circumstances. These limits can be context-dependent, varying based on factors such as the type of road the vehicle is traveling on, the weather conditions, traffic conditions, and the like. Constraints can include spatial constraints, such as minimum or maximum turning radius, preferred lane positions, or desired following distances from other vehicles.

Constraints can be defined in any suitable coordinate system, such as a global coordinate system, a local coordinate system tied to a map, or a local coordinate system anchored to the vehicle.

Constraints can be based on characteristics of the vehicle itself (such as its physical capabilities or limitations, its sensor suite, etc.), a specific task or mission that the vehicle is performing (such as navigating to a destination, following a lead vehicle, etc.), and an operating environment of the vehicle (such as the road network, traffic conditions, weather conditions, etc.).

Constraints can be explicitly or implicitly related to control parameters used for controlling a vehicle. For instance, a constraint can indicate a threshold for a following distance behind a lead actor. However, a motion planning system may not have an explicit control parameter for following distance. The motion planning system can, for instance, directly parameterize the trajectory in terms of control inputs to one or more control actuators. However, the control inputs can indirectly influence, and thus implicitly describe, in combination with additional world state information, a following distance. In this manner, for example, it should be understood that constraints can correspond to conditions that are to be satisfied by trajectories, and not necessarily limited to conditions on actual control values that parameterize a given trajectory. It is also to be understood, however, that constraints can include conditions on the actual control values that parameterize a given trajectory.

Constraints can have hierarchical definitions. For instance, global constraints can apply across all scenarios and trajectories. For example, certain extremes of acceleration may never be appropriate. A global constraint can indicate that a given parameter should always be below a particular value. The particular value can be arbitrarily selected. The particular value can be selected based on an observed or recorded trajectory.

Context-level constraints can apply to trajectories generated for navigating in particular contexts. For example, in some contexts, hard deceleration may be appropriate (e.g., to stop to allow an emergency vehicle to pass). In other contexts, the same level of deceleration may not be appropriate (e.g., in smooth-flowing traffic flow on a highway). In this manner, for instance, constraints can be limited to particular contexts or groups of contexts. Contexts can be identified by tags, labels, simulation identifiers, embedded scene representations, etc.

Trajectory-level constraints can apply to trajectories generated for traversing a specific scenario or assembly of objects in an environment. For instance, a particular arrangement of objects and actors can admit only a handful or even a single basin of low cost behavior. Trajectories generated from this set of basin(s) can be effectively equivalent even if not identical. Trajectory-level constraints can apply to these equivalent trajectories. Trajectory-level constraints can define boundaries on what behavior is acceptable when executing particular maneuvers in specific situations. Trajectory-level constraints can be used, for instance, when monitoring the generation or evaluation of new trajectories. A suboptimal trajectory can be identified and flagged as setting a boundary along a particular constraint dimension, and the motion planning system can be instructed to penalize (or not generate) trajectories that exceed the boundary along that constraint dimension.

Constraints can be tagged or otherwise marked or associated with a corresponding hierarchical definition.

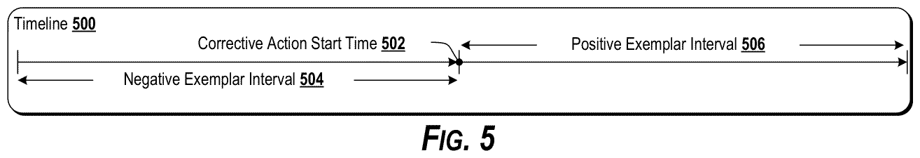

FIG. 4 is a block diagram of a system for generating constraint-labeled trajectories for machine-learned model training and evaluation according to some implementations of the present disclosure. Although FIG. 4 illustrates an example implementation of a system having various components, it should be understood that the components can be rearranged, combined, omitted, etc. within the scope of and consistent with the present disclosure.

Log data 412 can include data describing one or more trajectories describing the movement(s) of a vehicle through an environment. Trajectory data 414 can include values for one or more parameters characterizing a particular trajectory of an ego vehicle. Parameters can define a shape of a motion path, a movement of the ego vehicle, relationships to other objects in an environment of the ego vehicle, etc. For example, trajectory data 414 can include first parameter value(s) 416, second parameter value(s) 418, third parameter value(s) 420, etc., that respectively correspond to a first trajectory parameter, a second trajectory parameter, a third trajectory parameter, etc. The trajectory of the ego vehicle corresponding to trajectory data 414 can be generated by a machine-learned model in a motion planning system.

To label the trajectory described by trajectory data 414, a label generation system 422 can generate label data 424. Label data 424 can include a suboptimal condition indicator 426. Suboptimal condition indicator 426 can include data identifying and describing a suboptimal condition of the trajectory described by trajectory data 414. Label data 424 can include data describing time interval(s) 428. Time interval(s) 428 can include an interval within which the suboptimal condition persists. Time interval(s) 428 can include an interval preceding the onset of the suboptimal condition. Time interval(s) 428 can include an interval following the cessation of the suboptimal condition. Label data 424 can include data describing context(s) 430. Context(s) 430 can include data describing portions of the environment (e.g., objects, other actors/vehicles, etc.) that are relevant to the identification of the suboptimal condition.

Together, trajectory data 414 and label data 424 can form a labeled trajectory 432. Labeled trajectory 432 can form part of a training or evaluation set. Evaluation system(s) 434 (e.g., a training system, a validation system, etc.) can process at least a portion of labeled trajectory 432 to evaluate machine-learned model(s) 436. For example, evaluation system(s) 434 can use label data 424 to score trajectories output by machine-learned model(s) 436 (e.g., with a loss function) for training machine-learned model(s) 436 to improve the score.

For example, evaluation system 434 can evaluate machine-learned model 436 using trajectory data 414 generated by machine-learned model 436. Based on label data 424, which can indicate a suboptimal condition associated with trajectory data 414, a score or validation state can be assigned to machine-learned model 436.

Evaluation system 434 can evaluate machine-learned model 436 using trajectory data 414 that was not generated by machine-learned model 436. For instance, an evaluation system 434 can use a labeled trajectory as a reference point for a boundary of a trajectory constraint, and outputs of machine-learned model 436 can be evaluated by comparison to labeled trajectory 432.

A labeled trajectory 432 can provide online and offline evaluation signals. Evaluation system(s) 434 can use a labeled trajectory 432 offline to evaluate whether the motion planning system has a set of decision boundaries consistent with the labeled trajectory 432. For instance, evaluation system(s) 434 can use a labeled trajectory 432 to confirm whether a new version of a motion planning system respects a baseline set of decision boundaries such that a validation set of input scenarios result in output motion plans that align with the decision boundaries. Evaluation system(s) 434 can use a labeled trajectory 432 offline to cause a motion planning system (e.g., planning system 250) to learn improved decision boundaries. For instance, a motion planning system can be trained using labeled trajectory 432 to generate motion plans that are consistent with labeled trajectory 432. A labeled trajectory 432 can provide an online evaluation signal that constrains or otherwise provides a thresholding function for checking, scoring, ranking, or validating generated candidate trajectories.

Log data 412 can include data describing one or more trajectories of one or more vehicles. Log data 412 can include data generated by various sensors and systems onboard a vehicle. For instance, log data 412 can include data output from radar sensors, lidar sensors, cameras or other imaging sensors, ultrasonic sensors, GPS receivers, IMUs (inertial measurement units), and other sensors that are onboard the vehicle. Log data 412 can include data related to control inputs applied to the vehicle, such as steering angle, throttle position, brake pressure, and gear selection. Log data 412 can include map data or other external data sources indexed with sensor data (e.g., localized map data, localized weather data, etc.).

Log data 412 can describe the state of a vehicle and its environment over time. Log data 412 can include time history data, such as various parameter values indexed in time. Different values can be indexed on different time scales. For instance, a time scale can be determined by the sampling rate of a particular sensor.

Log data 412 can include raw sensor data. For example, log data 412 can include raw sensor returns for lidar data (e.g., unprocessed point clouds, etc.), raw image data, and the like.

Log data 412 can include processed data. For example, log data 412 can include data output by various systems of a vehicle (e.g., components of autonomy system 200). For instance, log data 412 can include data generated by a perception system, a planning system, or a control system of the autonomous vehicle. This can include, for example, object detection data, object classification data, object tracking data, candidate trajectory data, selected trajectory data, or executed trajectory data.

Log data 412 can include data describing an operating mode of an autonomous vehicle. For instance, log data 412 can indicate a disengagement of an autonomy system 200 from control of an ego vehicle. Disengagement events can be implicit. For instance, data indicating that a human operator onboard an autonomous vehicle touched a control surface (e.g., a steering wheel, brake or gas pedal, etc.) can be interpreted as a disengagement event.

Log data 412 can be obtained from real-world or simulated driving events. For example, log data 412 can be obtained from outputs of vehicle systems and devices operating in real-world scenarios (e.g., on roadways, on closed courses, etc.). Log data 412 can be obtained from outputs of vehicle systems and devices operating offline in simulated environments (e.g., with simulated sensor inputs). Log data 412 can be obtained from virtual instances of vehicle systems (e.g., an autonomy system 200 operating on a workstation or server device to conduct simulated driving tests).

Log data 412 can include annotations from a human reviewer. For instance, for real world or simulated log data 412, a system can present a subject trajectory (e.g., replay a recording thereof, such as a replay of a scenario rendered using log data 412) on a review interface for review by a human reviewer. The system can receive one or more inputs describing an annotation indicating a corrective action to initiate to correct a characteristic of the subject trajectory had the human reviewer been responsible for controlling the vehicle. The system can receive one or more inputs describing when to initiate the corrective action. The system can receive one or more inputs describing an annotation indicating an alternative trajectory or trajectory characteristic that would be preferable to the subject trajectory. In this manner, for instance, a corrective action initiated by a human reviewer can be determined retroactively, even if the human reviewer does not in fact operate or control the vehicle.

Trajectory data 414 can include any portion or type of data in log data 412 that characterizes a particular trajectory of an ego vehicle. Trajectory data 414 can include first parameter value(s) 416, second parameter value(s) 418, third parameter value(s) 420, etc., that respectively correspond to a first trajectory parameter, a second trajectory parameter, a third trajectory parameter, etc. Different parameter values can correspond to different aspects of the vehicle's state or the state of the environment along the trajectory.

Example trajectory parameters can define the shape of the motion path, the movement of the ego vehicle, relationships to other objects in the environment of the ego vehicle, and other relevant aspects of the trajectory. Trajectory parameters can indicate position (e.g., with respect to map elements, with respect to environmental elements, with respect to other actors, etc.), velocity (lateral, longitudinal, rotational, etc.), acceleration (lateral, longitudinal, rotational, etc.), jerk, or other dynamic properties of motion. A position parameter can describe the spatial coordinates of the vehicle at different points along the trajectory. A velocity parameter can describe the rate of change of the position over time. An acceleration parameter can describe the rate of change of velocity over time. A jerk parameter can describe the rate of change of acceleration over time. Parameters can be defined in any suitable coordinate system, such as a global coordinate system, a local coordinate system tied to a map, or a local coordinate system anchored to the vehicle.

Example trajectory parameters can indicate characteristics of the vehicle itself (such as its physical capabilities or limitations, its sensor suite, etc.), a specific task or mission that the vehicle is performing (such as navigating to a destination, following a lead vehicle, etc.), or an operating environment of the vehicle (such as the road network, traffic conditions, weather conditions, etc.).

Example trajectory parameters can include values explicitly or implicitly related to control parameters used for controlling a vehicle along a trajectory. For instance, a trajectory data 414 can indicate a threshold for following distance to a lead actor in a lane. However, a motion planning system might not have an explicit control parameter for following distance. The motion planning system might, for instance, directly parameterize the trajectory in terms of control inputs to one or more control actuators. However, the control inputs can indirectly influence, and thus implicitly describe, in combination with additional world state information, a following distance. In this manner, for example, it is to be understood that trajectory data 414 can correspond to conditions that are induced by trajectories, and not necessarily limited to values of actual control values that parameterize a given trajectory.

Trajectory data 414 can include parameters describing the state of the vehicle's environment. These can include, for instance, the positions, velocities, and accelerations of other vehicles or objects in the environment, as well as characteristics of the environment itself.

Trajectory data 414 can be represented in any suitable data structure or format, such as a time series, a matrix, a list, a table, or a database.

Example parameter(s) (e.g., first parameter value(s) 416, second parameter value(s) 418, third parameter value(s) 420, etc.) can be raw or processed values from log data 412.

Example parameter(s) (e.g., first parameter value(s) 416, second parameter value(s) 418, third parameter value(s) 420, etc.) can be computed to correspond to a constraint dimension of trajectory constraints 404. For instance, the parameter(s) can be formulated or constructed to allow for direct comparison with one or more constraints. For instance, if a constraint dimension corresponds to an acceleration limit, at least one parameter of trajectory data 414 can be an acceleration of the vehicle. This can be a direct measurement stored in log data 412 or a value computed based on measurements in log data 412. Similarly, for a constraint dimension indicating a certain minimum distance from other objects, a corresponding trajectory parameter could be the computed distance to the nearest object in the environment. This can be a direct measurement stored in log data 412 or a value computed based on measurements in log data 412.

Example parameter(s) can correspond to hand-constructed or heuristics. Such heuristics can be rules or methods which are created based on empirical knowledge and intuition (e.g., principles of physics, such as kinetic energy, projectile motion, etc.). For example, an example heuristic parameter that combines vehicle speed and distance to the nearest object can be a parameter indicating a quality of a buffer distance. Another example heuristic includes speed relative to traffic, indicating a difference between ego vehicle speed and a speed of surrounding traffic. Another example heuristic includes a lane centering measure based on a lateral distance of the vehicle from the center of its current lane. Another example heuristic includes a predicted path clearance value that indicates an estimated clearance around a future path of the vehicle.

Example parameter(s) can correspond to heuristics or inferred values generated by a machine-learned model. For example, clustering models can be used. Clustering models can analyze large amounts of trajectory data and identify patterns or clusters within the data. These patterns can then be used to generate new trajectory parameters that can be used to identify new constraint dimensions (e.g., new decision boundaries for the preferred behavior envelope). In other examples, a neural network can output a score or other value for a trajectory. The neural network can be trained to agree with human operators (e.g., human drivers, etc.) and human reviewers regarding the goodness of a particular trajectory. This network output can thus be a parameter of a trajectory in trajectory data 414. In an example, a machine-learned model can learn to predict a comfort level of a human passenger based on parameters such as the vehicle's acceleration or jerk and the roughness of a road surface.

Example parameter(s) can be input or assigned by a user. For example, a user can inject data into trajectory data 414 that might not be detected or detectable by sensors of the vehicle itself. For example, a human operator or human reviewer can input data describing a comfort level or confidence level associated with the trajectory.

Label generation system 422 can use one or more computing devices or systems to process trajectory data 414 and generate label data 424. Generation of label data can include automated inference or prediction of label values based on trajectory data 414. Generation of label data can include automated classification or designation of aspects of trajectory data 414 using deterministic rules or heuristics. Generation of label data can include receiving user input(s) describing attributes of trajectory data 414 and recording data describing the user input(s) in association with trajectory data 414 to form labeled trajectory 432.

Label generation system 422 can conduct or facilitate analysis of trajectory data 414 to determine whether and how the trajectory deviates from a preferred trajectory or condition. Label generation system 422 can generate label data that not only indicates that the trajectory is suboptimal but also characterizes how the trajectory is suboptimal with respect to a constraint dimension, and by how much. Label generation system 422 can use machine-learned models, statistical methods, or other computational techniques to identify suboptimal conditions in trajectory data 414. Label generation system 422 can generate label data based on the identified suboptimal conditions.

Label generation system 422 can process trajectory data 414 to identify features of a corrective action. A feature of a corrective action can include a change caused by the corrective action. A change in a trajectory parameter value caused by a corrective action can be informative of a suboptimal condition corrected by the corrective action. Label generation system 422 can characterize the suboptimal condition along a constraint dimension associated with the changed trajectory parameter(s).

Label generation system 422 can process trajectory data 414 to identify significant changes in one or more parameter values over time during the trajectory (e.g., a sudden braking action, a sudden steering action, etc.), including a change resulting from a disengagement (e.g., a steering input indicating human intervention during operation in an autonomous mode), or otherwise suggesting that a corrective action was applied (e.g., including a review action applied retroactively upon review of log data 412). In this manner, label generation system 422 can estimate the identity of a problematic trajectory parameter that precipitated the corrective action. For instance, for each disengagement, there can be a significant change in state for one or more trajectory parameters (e.g., speed, acceleration, steering angle, etc.) once the corrective action is applied (e.g., if a human operator performs a rapid lane-change after takeover, there can be a significant change in lateral velocity). In this manner, for instance, the trajectory parameter experiencing the change can be estimated to be a parameter that was intended to be changed—that is, a parameter that was suboptimal and was corrected by the correction.

Label generation system 422 can process trajectory data 414 to identify more subtle changes in one or more parameter values over time during the trajectory that nonetheless precipitated a corrective action. For instance, an analytical model (e.g., a heuristic-based model, a machine-learned model, etc.) can process trajectory data 414 to identify patterns in one or more intervals of trajectory data 414 that are different in later intervals. If a change in the detected patterns can be correlated to a disengagement event (e.g., over one or more samples of trajectory data 414), then label generation system 422 can identify that the particular pattern-even if seemingly subtle, based on raw magnitude or frequency—can indicate a suboptimal condition that is to be avoided.

Label generation system 422 can determine a direction of suboptimality. For instance, the sign of a change in a trajectory parameter associated with the corrective action (e.g., a change in the suboptimal parameter value) can indicate a direction in which the value was suboptimal prior to the corrective action. For instance, if a corrective action causes an increase in the value (e.g., a positive change direction), then label generation system 422 can determine that the pre-correction value was too low, which can inform a lower bound on the trajectory parameter. Similarly, if a corrective action causes a decrease in the value (e.g., a negative change direction), then label generation system 422 can determine that the pre-correction value was too high, which can inform an upper bound on the trajectory parameter.

Label generation system 422 can receive data input via a user interface by a human user. For instance, the human user can review a representation of a vehicle's trajectory, such as a graphical rendering or a video replay, and input data indicating observed or perceived suboptimal conditions. The human user can input these labels via a user interface, which can be a graphical user interface, a command line interface, or any other type of interface that enables user input. Label generation system 422 can receive the data and generate label data 424 based thereon.

Label data 424 can include information that characterizes a suboptimal condition associated with a trajectory of a vehicle with respect to trajectory constraints 404. Label data 424 can be generated based on trajectory data 414 or other observed or inferred information about the vehicle's trajectory. The label data 424 can include a variety of different types of information that can be used to characterize the suboptimal condition of the vehicle's trajectory. Label data 424 can include a suboptimal condition indicator 426, time interval(s) 428, or context(s) 430.

Label data 424 can be stored in any appropriate format (e.g., JSON, xml, databases, etc.). Label data 424 can be stored together with trajectory data 414 or stored separately with a reference pointing to related trajectory data 414. Label data 424 can be versioned.

Label data 424 can include one or multiple data types. Label data 424 can include text data, image captures, audio recordings, sensor time histories, etc.

Suboptimal condition indicator 426 can include data that identifies or describes a suboptimal condition of a trajectory described by trajectory data 414. Suboptimal condition indicator 426 can include, for example, data indicating that the vehicle's speed was too high, that the vehicle's path was too close to an obstacle, that the vehicle's path deviated from a preferred path, or that the trajectory violated some other constraint or preference.

Suboptimal condition indicator 426 can be an indicator selected from or otherwise matched to a set of possible or known suboptimal conditions. For example, based on trajectory constraints 404, one or more candidate options for suboptimal condition indicator 426 can be available. Label generation system 422 can facilitate selection of one of the candidate options (e.g., by a human reviewer, by an automated review system, etc.).

For example, a trajectory parameter constraint can be associated with velocity. Thus, an operation of label generation system 422 can facilitate a determination of whether the trajectory described by trajectory data 414 was “too slow” (e.g., based on machine analysis of the trajectory or based on human feedback) for a given driving scenario. If so, then label generation system 422 can proceed to generate and store a velocity-based suboptimal condition indicator.

Suboptimal condition indicator 426 can be an indicator of a suboptimal condition associated with trajectory data 414 that was not an existing candidate option. For instance, a suboptimal condition can be associated with a novel suboptimal event that was previously not addressed. For instance, a particular combination of trajectory parameters can be identified as suboptimal (e.g., based on detecting a disengagement event). The particular combination of trajectory parameters can be used to generate a new constraint dimension aligned with that combination of parameters, such that the new constraint dimension indicates acceptable and suboptimal ranges of a value of the combination of parameters.

For example, suboptimal condition indicator 426 can correspond to a magnitude of first parameter value along a first constraint dimension in combination with a magnitude of a second parameter value along a second constraint dimension. For example, a following distance constraint dimension can have an acceptable range and a suboptimal range. The boundary can vary along another dimension, such as an amount of lane overlap. For instance, a close following distance that might be suboptimal when 100% within the same lane as a leading actor might be acceptable with only 5% lane overlap (e.g., due to less rear burden on the leading actor). In this manner, for instance, suboptimal condition indicator 426 can characterize a suboptimal condition along multiple constraint dimensions joined by one or more Boolean operators (e.g., distance AND overlap).

Time interval(s) 428 can indicate one or more temporal intervals associated with the indicated suboptimal condition. An interval can include an interval before the suboptimal condition, an interval after the suboptimal condition, an interval during which the suboptimal condition persists, etc. Time interval(s) 428 can indicate when the suboptimal condition occurred, when it began, when it ended, or any combination thereof. Time interval(s) 428 can be defined in terms of absolute or relative time.

Context(s) 430 can include information about the environment or situation in which the suboptimal condition occurred. This can include, for example, information about the location of the vehicle, the location of other objects or actors in the environment, the current or historical state of the vehicle or the environment, the task or mission that the vehicle was performing, or other situational or environmental factors. Context(s) 430 can provide information that helps to explain or understand the suboptimal condition, or that helps to predict or prevent similar suboptimal conditions in the future.

Context(s) 430 can include any data ingested or generated by autonomy system 200. For example, context(s) 430 can include sensor data 204, map data 210, or other data. Context(s) 430 can include data from any one or more of localization system 230, perception system 240, planning system 250, or control system 260. For example, context(s) 430 can include data describing objects in the environment (e.g., from perception system 240) and decisions made with respect to those objects (e.g., from planning system 250).

A representation of an example instance of label data 424 is provided below:

Label Data 424

```
Log Data Locator (e.g., pointing to a location of trajectory
data 414 in log data 412)
Time interval 428 (e.g., indicating portion of trajectory data
414 pertaining to label)
Suboptimal Condition Indicator(s) 426
Constraint dimension (e.g., one or more of:
  Velocity
  Arclength
  Acceleration
  Jerk
  Lateral velocity
  Non-state, non-control trajectory features such as
  lateral displacement from reference wickets, or
  generally any learned or hand-tuned function f:
  trajectory → scalar)
Logical connective (e.g., Boolean operator joining two or
more constraint dimensions)
Constraint direction (e.g., indicating whether an upper bound
or a lower bound was violated)
Context(s) 430
Actor ID (e.g., relevant actors in scenario to determination of
suboptimal condition)
Actor decision (e.g., predicted decisions made by actor,
decisions made by ego vehicle with respect to actor, etc.)
```

Labeled trajectory 432 can include a matching of at least one instance of label data 424 to a particular trajectory. Labeled trajectory 432 can include an instance of a label paired with an instance of a trajectory. Labeled trajectory 432 can include a single trajectory with multiple labels. For example, multiple instances of label data 424 can be associated with a single trajectory.

For example, a trajectory can have labels associated with multiple users (e.g., multiple reviewers who review and annotate the same trajectory with corrective actions). Variation in the corrective actions from the reviewer(s) can be smoothed over, such as by applying a weighted average. For instance, multiple reviewers can describe a corrective action that would traverse a particular lane. The multiple reviewers can describe the timing of the lane change, a trajectory for leaving or entering a lane, etc. Each reviewer's annotations can be associated with a label. Deviations between the timing and the angle of the trajectory can be smoothed (e.g., via averaging) to obtain an overall label based on the individual labels.

Labeled trajectory 432 can include a trajectory with multiple labels that each describe a different suboptimal aspect of the trajectory. For example, a trajectory can be suboptimal in multiple independent ways. For example, straddling a centerline across multiple lanes can be a suboptimal driving behavior if otherwise unnecessary for object or debris avoidance, etc. Similarly, driving too slow can also be suboptimal if circumstances do not warrant traveling much slower than the expected roadway speed. Label data 424 can be generated for each suboptimal aspect separately, thereby providing independent training/evaluation signals to help a motion planner learn to avoid straddling lanes and learn to avoid driving too slowly, and not simply learning to avoid the combination of straddling lanes and driving too slowly.

Labeled trajectory 432 can be collected with other labeled trajectories to form one or more datasets. A dataset of labeled trajectories 432 can be a training dataset for training a machine-learned model. A dataset of labeled trajectories 432 can be a test dataset for testing a trained machine-learned model. A dataset of labeled trajectories 432 can be a validation dataset for validating a trained machine-learned model.

Evaluation system(s) 434 can include one or more computing systems that can process labeled trajectory(ies) 432 to evaluate one or more machine-learned models 436. Evaluation system(s) 434 can curate, catalog, index, or otherwise organize labeled trajectory(ies) 432. Evaluation system(s) 434 can retrieve labeled trajectory(ies) 432 from one or more databases or other storage architectures.

Evaluation system(s) 434 can process labeled trajectory(ies) 432 to update trajectory constraints 404. For example, trajectory constraints 404 can contain an initial constraint value for a constraint (e.g., first parameter constraint 406). Evaluation system(s) 434 can process a labeled trajectory 432 which was labeled as suboptimal with respect to the constraint but has a measured value for the parameter that is within the initial constraint value. Evaluation system(s) 434 can determine that the initial constraint value should be updated based on the measured value. In this manner, for instance, the values of trajectory constraints 404 can be learned/updated based on labeled trajectory(ies) 432.

In another example, evaluation system(s) 434 can determine a new constraint to add to trajectory constraints 404 that is based on a combination of parameters. Evaluation system(s) 434 can process a labeled trajectory 432 which was labeled as suboptimal with respect to a particular constraint or combination of constraints but has a measured value for the corresponding parameter that is within the initial constraint values of trajectory constraints 404. Evaluation systems) 434 can identify a combination of parameter values based on the labeled trajectory to add a new constraint to trajectory constraints 404, such that the labeled trajectory would also be labeled as suboptimal based on a failure to satisfy the new constraint.

Evaluation system(s) 434 can perform validation of a component of autonomy system 200. For example, evaluation system(s) 434 can perform validation of any portion of localization system 230, perception system 240, planning system 250, control system 260, or a combination thereof, etc. Validation can include a final check of system performance to ensure compliance with a desired set of performance benchmarks. Validation can be evaluated as a pass/fail test. For example, suboptimal trajectories can be labeled with a binary label (e.g., pass/fail), and a given system responsible for generating the suboptimal trajectories can inherit a score from its generated trajectories (e.g., pass/fail). For example, a system that generates a suboptimal trajectory can receive a “fail” score. A system that generates a plurality of suboptimal trajectories can receive a numerical score based on a count of “pass” or “fail” trajectories.

Evaluation system(s) 434 can describe behavior of a component of autonomy system 200 in a structured manner. For example, evaluation system(s) 434 can analyze label data 424 across a plurality of labeled trajectories 432 to explore trends in the suboptimal behavior. For example, evaluation system(s) 434 can identify and assess failure modes (e.g., does the ego vehicle tend to apply a suboptimal amount of steering-too high or too low; does the ego vehicle tend to apply a suboptimal amount of braking force-took high or too low, etc.).

Evaluation system(s) 434 can rank suboptimal behavior examples or behavior types to identify, for example, top-K deviations from preferred behavior. For example, evaluation system(s) 434 can obtain a top-K listing of constraints that are violated. Evaluation system(s) 434 can slice the data along other axes in conjunction with such ranking. For instance, evaluation system(s) 434 can generate a listing of contexts (e.g., environmental scenarios, other factors) in which a particular constraint is most often violated. Evaluation system(s) 434 can determine a strength of the relationship between the context(s) and the violation of the constraint (e.g., a correlation coefficient, etc.). Evaluation system(s) 434 can identify a relevance of such context(s), such as identifying a most relevant context (e.g., a context expected to be determinative of a constraint violation). In this manner, for instance, evaluation system(s) 434 can help elucidate complex behavioral patterns of operational systems and help identify root causes of suboptimalities within the systems.

Evaluation can include training of a component of autonomy system 200 (e.g., machine-learned model(s) 436). For example, evaluation system(s) 434 can perform training of any portion of localization system 230, perception system 240, planning system 250, control system 260, or a combination thereof, etc.

For example, evaluation system(s) 434 can train a motion planning model by evaluating a trajectory output by the motion planning model using labeled trajectory 432. Evaluation system(s) 434 can use labeled trajectory 432 to evaluate the motion planning model by, for instance, determining a similarity between the trajectory output by the model and at least a portion of labeled trajectory 432. Evaluation system(s) 434 can use labeled trajectory 432 by, for instance, scoring the output trajectory using a scoring model trained using labeled trajectory 432. For example, one or more components of evaluation system(s) 434 can be configured based on labeled trajectory 432 (e.g., trained using labeled trajectory 432), thereby enabling such one or more components to in effect use information obtained from labeled trajectory 432.

Evaluation system(s) 434 can train other models in addition to or instead of a motion planning model. For example, evaluation system(s) 434 can train one or multiple models in an end-to-end manner. For instance, evaluation(s) 434 can train any portion of localization system 230, perception system 240, or a combination thereof, etc. based on a performance of a downstream motion planning model in generating/selecting motion plans based on perception data generated by the perception system.

Time interval(s) 428 can designate different portions of trajectory data 414 that can provide different training or validation signals. A trajectory described by trajectory data 414 can be a suboptimal trajectory having one or more parameters (e.g., control or state values) that deviate from a corresponding constraint value (e.g., of trajectory constraints 404) in the circumstances (e.g., braking more abruptly than desired). A human operator can initiate a corrective action to correct the trajectory. The portions of the trajectory on either side of this corrective action can provide different exemplar signals.

Machine-learned model(s) 436 can be or include any component of an autonomy system 200 or other system that uses learned parameters. Machine-learned model(s) 436 can be or include neural networks to perform various functionality. Machine-learned model(s) 436 can integrate learned and hand-crafted features within model(s) 436 to perform desired functionality. Machine-learned model(s) 436 can include convolutional neural networks, graph neural networks, recurrent neural networks, LSTM networks, transformer-based models, feedforward networks, multilayer perceptrons, linear models, nonlinear models, denoising models, etc.

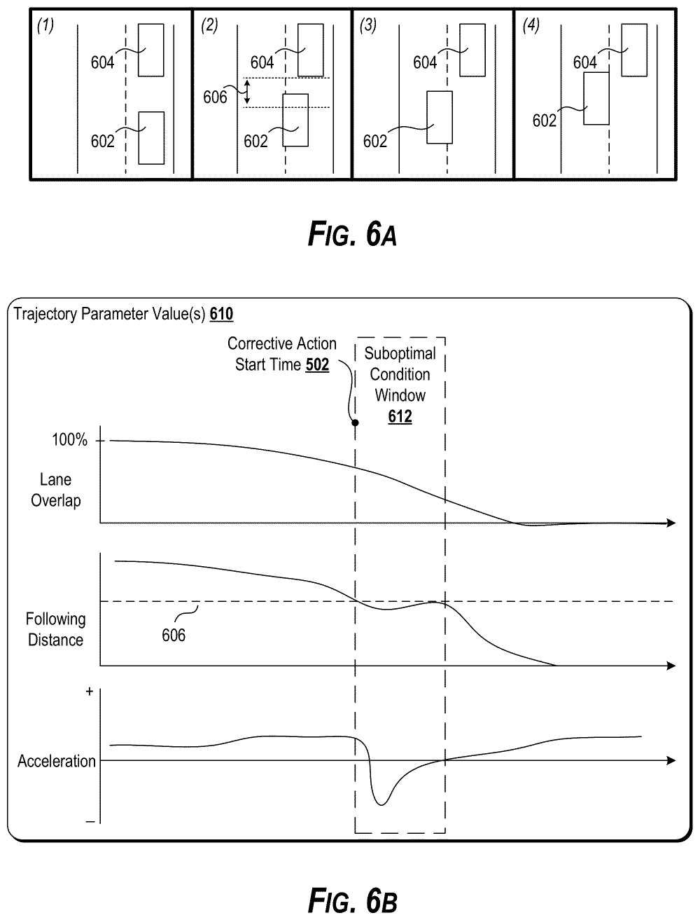

FIG. 5 is an example timeline 500 of trajectory described by trajectory data 414. A corrective action can occur at a corrective action start time 502. Prior to corrective action start time 502, a negative exemplar interval 504 can contain trajectory data descriptive of suboptimal behavior that precipitated (e.g., induced, triggered, otherwise led to) the corrective action. For example, the trajectory during negative exemplar interval 504 can be an example of a suboptimal trajectory. This can be useful for training a machine-learned motion planner regarding what not to do. At some time after corrective action start time 502, a positive exemplar interval 506 can begin. The trajectory during positive exemplar interval 506 can be an example of a recovery trajectory useful for training a machine-learned motion planner regarding how a human would respond to and recover the vehicle from a suboptimal initial state.

Time interval(s) 428 can include one or more values that indicate any one or more of corrective action start time 502, negative exemplar interval 504 (e.g., one or more endpoints thereof, a duration thereof, etc.), or positive exemplar interval 506 (e.g., one or more endpoints thereof, a duration thereof, etc.).

Corrective action start time 502 can be a time associated with initiation of a corrective action. For a human operator disengagement event (e.g., a human operator's disengagement of at least one autonomy operation to assume manual control of at least an aspect of control of a vehicle), corrective action start time 502 can be a time at which the disengagement begins. This can be a time at which the human operate turns off the autonomy systems, touches a manual control surface (e.g., a steering wheel, a brake or accelerator pedal, etc.), or the like. Corrective action start time 502 can be a time at which a corrective action control input is provided that overrides or otherwise assumes control of the vehicle. For instance, corrective action start time 502 can be a time at which a human operator turns a steering wheel, presses a pedal, etc. In this manner, for instance, a human operator touching a steering wheel to be prepared to assume control can be distinguished from a steering input, with the latter potentially providing a stronger signal of an indication of suboptimal behavior.

Corrective action start time 502 can be a time associated with corrective actions formed by annotations recorded in association with trajectory data 414. For instance, a human reviewer can review a replay of trajectory data 414 and indicate one or more changes to a trajectory described thereby (e.g., to travel a different path, to travel at a different speed, etc.) in an annotation. This annotation can indicate a corrective action. The human reviewer can interact with an input device to enter temporal information associated with the corrective action. Corrective action start time 502 can be a time at which an annotated trajectory diverges from the trajectory described by trajectory data 414. Corrective action start time 502 can be a time at which a specific maneuver is assigned to be performed (e.g., an annotation indicating to apply brakes at time T_brakes).

Negative exemplar interval 504 can correspond to a portion of trajectory data 414 beginning at an initial start time and ending at or before corrective action start time 502. An initial start time of negative exemplar interval 504 can be set to a fixed offset from corrective action start time 502 (e.g., a number of seconds, such as about 2, 3, 4, or 5 seconds, such as about 10, 15, or 20 seconds, etc.).

Negative exemplar interval 504 can begin at an initial offset value determined by analysis of trajectory data 414. For example, label generation system 422 can analyze trajectory data 414 to identify a time at which the suboptimal behavior begins. This time can be the initial start time of negative exemplar interval 504. The time at which suboptimal behavior begins can correspond to a time at which a constraint is violated. Label generation system 422 can process trajectory data 414 and label data 424 with a machine-learned model configured to output a start time of behavior relevant to the suboptimal behavior identified in label data 424.

Positive exemplar interval 506 can correspond to a portion of trajectory data 414 beginning at or shortly after corrective action start time 502 and ending at an end time. A start time for positive exemplar interval 506 can include a buffer to account for control input delay, latency, or hysteresis that can occur after disengagement is first detected.

Designation of negative exemplar interval 504 can occur prior to generation of label data 424. For example, label generator 422 can label trajectory data 414 corresponding to negative exemplar interval 504 and trajectory data 414 corresponding to positive exemplar interval 506 can be associated with a dataset of positive exemplars for imitation (e.g., a dataset containing trajectories recorded of human drivers).

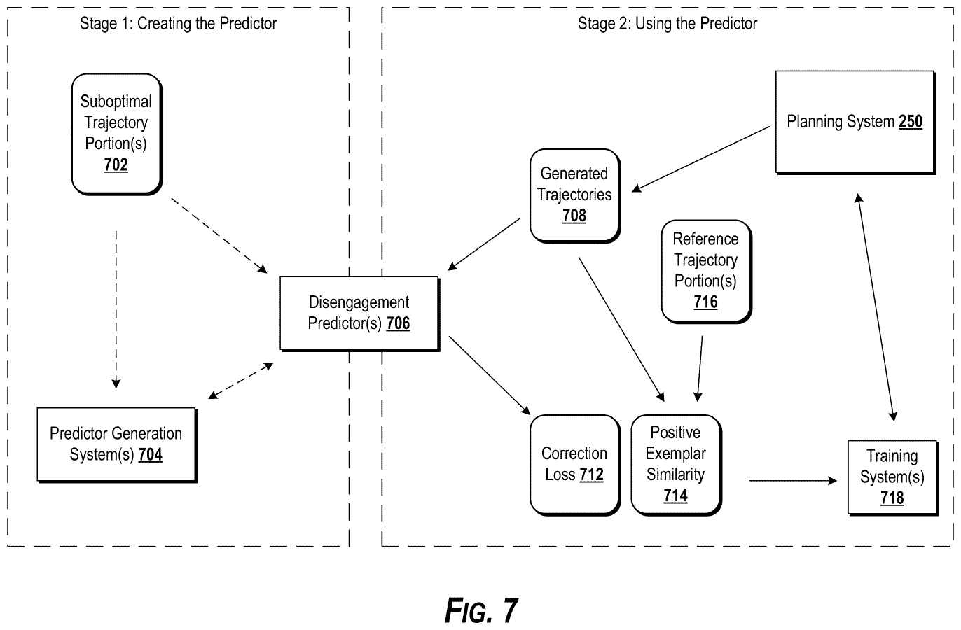

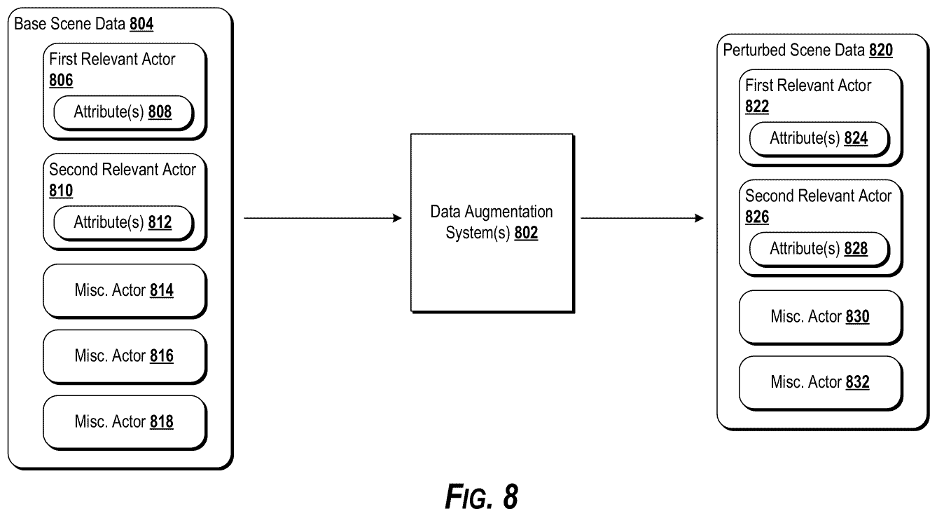

FIG. 6A includes example snapshots of an illustrative trajectory and distinguishing features of its corresponding intervals. Panel (1) depicts an ego vehicle 602 following an actor vehicle 604 in a lane. As drawn, the roadway can include two forward-direction lanes in which both vehicles are free to move and pass each other as needed.

Panel (2) depicts ego vehicle 602 initiating a lane change and passing maneuver to pass actor vehicle 604 while crossing within an in-lane following distance constraint 606. This can be the onset of a suboptimal condition associated with the movement of ego vehicle 602.

Panel (3) depicts ego vehicle 602 implementing a corrective action to stop moving closer to actor vehicle 604 but continue to move out of the lane. A following distance constraint can vary as a function of lane overlap. At full lane overlap (e.g., ego vehicle 602 being 100% in the same lane as actor vehicle 604), the following distance constraint can be at in-lane following distance constraint 606. The preferred following distance constraint can decrease as lane overlap decreases. For instance, a preferred minimum following distance can be lower when lane overlap is only 50%. In this manner, for instance, one corrective action to correct the overrun of constraint 606 is to decrease lane overlap. Another corrective action is to reduce speed relative to actor vehicle 604.

Panel (4) depicts ego vehicle 602 completing the transition out of the original lane and completing the pass maneuver.

FIG. 6B is an example snapshot of a set of hypothetical trajectory parameter value(s) 610 that can correspond to the illustrative trajectory of FIG. 6A. At an initial state before corrective action start time 502, ego vehicle 602 can be 100% within the lane of actor vehicle 604. Ego vehicle 602 can have a following distance above in-lane following distance constraint 606. Ego vehicle 602 can maintain forward acceleration to initiate a passing maneuver.

As the timeline approaches corrective action start time 502, the following distance begins to approach and cross constraint boundary 606. At this point, the corrective action can be initiated. For instance, as reflected in the negative acceleration, ego vehicle 602 can stop accelerating and can decrease speed to hold a following distance while continuing to transition out of lane. Ego vehicle 602 can hold a following distance at or near the constraint until the lane overlap value reaches a value sufficient to relax the following distance constraint. At this point, the suboptimal condition can be released, marked by an end of suboptimal condition window 612.

As previously described, label generation system 422 can detect suboptimal conditions, and attributes thereof (e.g., a directionality, a corresponding constraint dimension, etc.) based on analysis of trajectory parameter values and their changing states over time. For example, label generation system 422 can process trajectory parameter values 610 and determine that a corrective action included a change in following distance (e.g., via a control input that directly adjusted acceleration). Acceleration can be an absolute acceleration (e.g., with respect to a world reference frame) or a relative acceleration (e.g., with respect to actor vehicle 604). In this manner, for instance, acceleration can reflect a relative motion with respect to actor vehicle 604, such that the sudden variation in acceleration can likewise be used to identify a correction along a following distance constraint dimension.

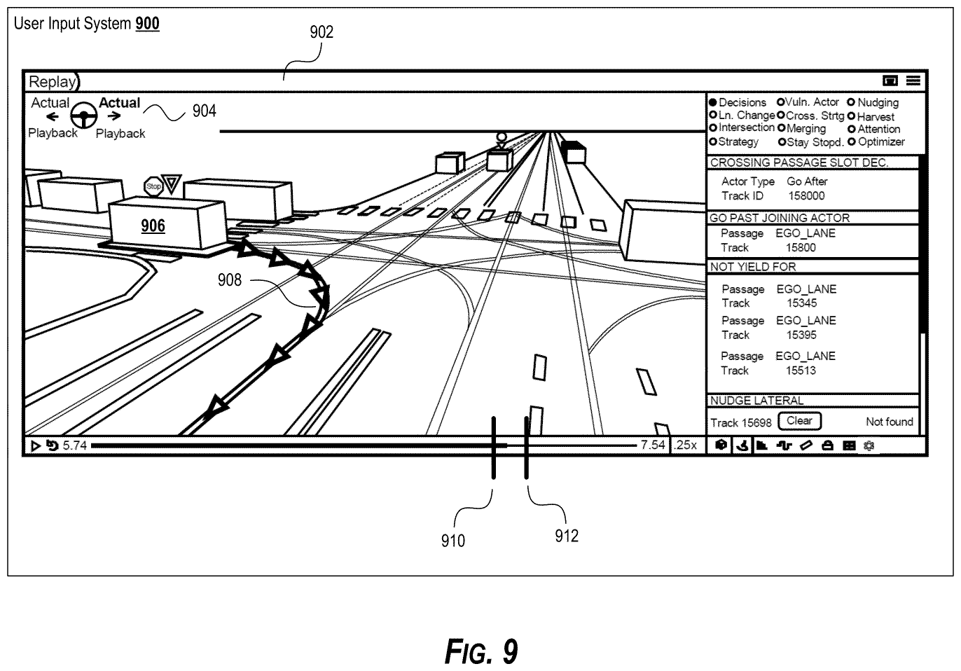

FIG. 7 is a block diagram of a training technique for training a machine-learned motion planning model using constraint-labeled trajectories, according to some aspects of the present disclosure. In particular, FIG. 7 illustrates an example technique for using negative training exemplars from suboptimal trajectory portions for training a performance of a model. The example technique can proceed in two stages.

In stage 1, an example system (e.g., evaluation system(s) 434) can obtain suboptimal trajectory portion(s) 702. Predictor generator system(s) 704 can store or otherwise use suboptimal trajectory portion(s) 702 to generate or learn disengagement predictor(s) 706. Disengagement predictor(s) 706 may be a function that outputs a probability of disengagement of an autonomous vehicle given a particular input trajectory. For example, the disengagement predictor(s) 706 may be a hinge loss function that compares an input trajectory to a suboptimal trajectory or portion thereof (e.g., suboptimal trajectory portion(s) 702) to generate a loss.

Disengagement predictor(s) 706 can include parameters obtained using predictor generation system(s) 704 based on suboptimal trajectory portion(s) 702, parameters obtained directly from suboptimal trajectory portion(s) 702, or both. Disengagement predictor(s) 706 can process an input trajectory or features thereof to generate values that estimate a likelihood of correction of the input trajectory.

In stage 2, an example system (e.g., evaluation system(s) 434) can implement at least a portion of planning system 250 to generate one or more generated trajectories 708. Generated trajectories 708 can describe a motion of an autonomous vehicle through an environment in a real or a test scenario (e.g., logged from real-world driving, captured from a simulation, etc.). Disengagement predictors 706 can process generated trajectories 708 to generate a disengagement or correction loss 712. The correction loss 712 can include or be based on a value obtained from disengagement predictor(s) 706 with respect to generated trajectories 708. The correction loss 712 can be combined with a loss derived from a positive exemplar similarity 714 that corresponds to an alignment between generated trajectories 708 and reference trajectory portion(s) 716.

Suboptimal trajectory portion(s) 702 can include portions of trajectory data 414 preceding a corrective action start time. For example, suboptimal trajectory portion(s) 702 can be a part of trajectory data 414 that describes suboptimal behavior of an autonomous vehicle.

Predictor generation system(s) 704 can include a component of a system (e.g., evaluation system 434) that processes suboptimal trajectory portion(s) 702 to create or initialize disengagement predictors 706. For instance, predictor generation system(s) 704 can include a training system to train a machine-learned model (e.g., of disengagement predictor(s) 706) to predict a likelihood that corrective action will be needed or desired for a particular trajectory. Predictor generation system(s) 704 can include a framework for implementing a disengagement predictor 706 directly from suboptimal trajectory portions 702.

In this manner, for instance, a training system can implement training of different models at different scales. For instance, a first training loop can operate to improve a performance of a disengagement predictor 706 (stage 1). A second training loop can use the trained disengagement predictor 706 to train or evaluate a machine-learned motion planning model (stage 2). The training iterations can be manual or automated. Parameters learned during training can be automatically updated or hand-tuned based on evaluation results.

Disengagement predictor(s) 706 can include one or more predictors (e.g., an ensemble) that can indicate a likelihood that corrective action would be taken by a human operator based on the trajectory. For instance, a given labeled trajectory 432 that identifies a violation of a particular constraint can provide a reference point for estimating a probability of the violation (and associated correction) occurring in a different trajectory. For example, a probability of a correction being applied to a respective trajectory because of a value of a certain parameter can be based on a difference between the value of that certain parameter in that respective trajectory and the value of that certain parameter in a corresponding labeled trajectory 432 that indicates the violated constraint.

Disengagement predictor(s) 706 are described for the sake of illustration in terms of disengagement of a human operator who operates an autonomous vehicle by disengaging an autonomous control system to correct a motion of the autonomous vehicle. However, it should be understood that disengagement predictors 706 are an example of a corrective action predictor, which can refer more generally to a predictor for corrected actions from various sources (e.g., human reviewers).

An example overall disengagement predictor can be based on an ensemble of per-parameter disengagement predictors. The ensemble can include multiple labeled trajectories 432 that each indicate a threshold parameter value for each state. An overall disengagement probability can be proportional to a maximum probability of disengagement with respect to an individual parameter, or

$$P ( disengagement \vert context ) ∝ {max}_{i} {P}_{i} ( disengagement \vert context )$$

The probability of disengagement induced by a value a given parameter can be estimated using a hinge loss. The probability of disengagement caused by a value a given parameter can be estimated using a sigmoid to normalize the hinge loss output. Other activation functions can be used instead of or in addition to a sigmoid.

In an example, (e.g., for upper-bound violations),

$${P}_{i} ( disengagement \vert context ) = sigmoid ( hinge ( x [ {parameter}_{i} ] - bound + {margin}_{i} ) )$$

where margin; are parameter-specific margins and bound is the expected bound based on available data (e.g., based on the labeled trajectories 432. In an example, (e.g., for lower-bound violations),

$${P}_{i} ( disengagement \vert context ) = sigmoid ( hinge ( bound + {margin}_{i} - x [ {parameter}_{i} ] ) )$$

The margin for a parameter can set a value that biases the predictor toward a particular outcome as desired. For instance, for upper bound violations, the margin can effectively decrease the constraint value, thus indicating suboptimality before the value reaches the true constraint value, building in allowances for uncertainty in the value of the constraint. For instance, for lower bound violations, the margin can effectively increase the constraint value, thus indicating suboptimality before the value reaches the true constraint value, building in allowances for uncertainty in the value of the constraint.

Generated trajectories 708 can include any trajectory that is processed by planning system 250. Generated trajectories 708 can be obtained from real-world operations of planning system 250. Generated trajectories 708 can be obtained from simulated operations of planning system 250.

A loss function can be computing using one or more loss values. A loss function can be implemented to evaluate a performance of planning system 250 in outputting generated trajectories 708.

Disengagement loss 712 can include at least a portion of a loss function that evaluates how likely a disengagement can be. Disengagement predictor loss 712 can be generated based on disengagement predictor(s) 706. An example implementation of such a loss is as follows.

$$loss = {\sum }_{i}^{‖ states ‖} {ViolationMask}_{{state}_{i}} \cdot [ hinge ( x [ {state}_{i} ] - {x}^{*} [ {state}_{i} ] + {margin}_{i} ) ,$$

$$hinge ( {x}^{*} [ {state}_{i} ] - x [ {state}_{i} ] + {margin}_{i} ) ]$$

where
x*=AV trajectory from disengagement
   x=sample trajectory
ViolationMask=[1,0] or [0, 1] for upper and lower bound, respectively with a respective disengagement predictor 706 corresponding to a summand associated with a respective value of i.

The disengagement predictor loss 712 can be based on and include disengagement predictors 706. A disengagement predictor 706 for a particular state i can include at least one constraint-labeled trajectory that is associated with violation of the state i. A disengagement predictor loss 712 can be computed using at least two disengagement predictors 706 for a given state i: one constraint-labeled trajectory that is associated with violation of the state i in an increasing direction and one constraint-labeled trajectory that is associated with violation of the state i in a decreasing direction.

In an example, x*[state_i] of disengagement predictor loss 712 can correspond to a “bound” of the disengagement predictors 706. In this manner, for instance, a disengagement predictor loss 712 summed over all the parameter states (e.g., over all the disengagement predictor(s) 706) can accumulate loss from each bounded parameter state.

Positive exemplar similarity 714 can include at least a portion of a loss function that evaluates another metric of goodness or error. Positive exemplar similarity 714 can be obtained from various costing or scoring functions. An example scoring function includes a similarity measure between generated trajectories 708 and reference trajectory portion(s) 716.

A loss function can use an indicator to select between positive exemplar losses (e.g., based on similarity) and negative exemplar losses (e.g., based on constraint violation) based on the type of exemplar provided to a loss function. For example, each training exampled can be labeled as a positive example or a negative example (e.g., with a “1” or a “0,” respectively). In this manner, an aggregated loss can be expressed as follows.

$$ModelLoss = label * {loss}_{positive} + ( 1 - label ) * {loss}_{negative}$$

A loss function can include different weights on different categories of losses. For example, a model can be trained with greater weight on negative examples (e.g., to compensate for lower representation in a training dataset).

Reference trajectory portion(s) 716 can include portions of reference trajectories against which generated trajectories 708 can be compared.

Training system(s) 718 can include a component of system(s) 434 that implements one or more training regimens to update parameters of planning system 250 based on a loss function. For example, training system(s) 718 can implement various optimization algorithms, such as backpropagation or black-bock optimization techniques to improve a performance of planning system 250 based on a loss function.

Disengagement predictor(s) 706 can be used to generate labels for other observed log data. For example, given an input trajectory, disengagement predictor(s) 706 can predict a half-space for the trajectory parameters. For example, disengagement predictor(s) 706 can help identify a half space for trajectory parameters that would decrease a probability of a corrective action. This estimate can then be used to automatically label the trajectory as suboptimal or not suboptimal.

FIG. 8 is a block diagram of an example data augmentation pipeline for increasing an amount of evaluation examples. In general, negative exemplars can be present in lower quantities in datasets that are reflective of typical driving behavior. For example, a dataset recorded from driving logs (e.g., real or simulated) from an autonomy system 200 can reflect progress in development of the autonomy system 200: over time, as the system improves, the dataset will reflect less and less suboptimal behavior. This progress can come at the expense of the quantity of negative training examples.

To increase a population of negative exemplars, a data augmentation system 802 can process base scene data 804. Base scene data 804 can describe a scene associated with a suboptimal trajectory portion identified in label data 424. Base scene data 804 can include one or more relevant actors indicated in label data 424 associated therewith. A first relevant actor 806 can have salient attributes 808 (e.g., attributes that effect a status of base trajectory 804 as suboptimal) and a second relevant actor 810 can have salient attributes 812. Base scene data 804 can also contain miscellaneous other actors 814, 816, 818 that are not indicated as relevant in label data 424 associated therewith.

Data augmentation system(s) 802 can generate perturbed scene data from base scene data 804. Perturbed scene data 820 can contain a different first relevant actor 822 that has salient attributes 824 that are consistent with salient attributes 808 of first relevant actor 806. Perturbed scene data 820 can contain a different second relevant actor 826 that has salient attributes 828 that are consistent with salient attributes 812 of second relevant actor 810. Perturbed scene data 820 can also include miscellaneous other actors 830, 832 that are not constrained to align with miscellaneous other actors 814, 816, 818. In this manner, for instance, perturbed scene data 820 can provide another training scene in which the suboptimal trajectory presents the same suboptimal behavior (e.g., with respect to first relevant actor 822 and second relevant actor 826) in a different context, thereby improving a robustness and diversity of the dataset.

In general, label data 424 can indicate actors (and decisions with respect to those actors) that are salient to the suboptimality of the labeled trajectory 432. One example can be a scenario in which an ego vehicle executed an undesirable lane change in front of a fast-moving rear actor. The rear actor can be a relevant actor, and a salient attribute of the rear actor can be its closing speed. Thus, to create additional examples from this baseline, other scenes can be generated in which the ego vehicle executes the lane change in front of the rear actor, except that the rear actor's speed is even higher (e.g., more suboptimal). In this manner, for example, the salient attribute of the perturbed rear actor can be consistent with the salient attribute of the baseline-both result in the suboptimal trajectory being suboptimal. By holding the salient attributes consistent in the perturbed example, data augmentation system(s) 802 can obtain another suboptimal example for the dataset.

To maintain consistency between salient features in perturbed scene data 820 and base scene data 804, perturbations can be subject to half space constraints. For example, in the above example, significantly decreasing a speed of the rear actor may render the lane change no longer suboptimal, thereby diminishing the training value as a negative example. Perturbations can be guided to maintain a suboptimal status of the resulting examples. This can be accomplished by perturbing the base scene data 804 in directions along constraint dimensions that increase a violation of the constraints. The perturbations can be applied to one or more actors to achieve this goal. For instance, the closing speed can be increased by either increasing a speed of the rear actor, decreasing a speed of the ego vehicle, or both.

Perturbed values can be sampled at random (e.g., subject to any constraints, such as a half-space constraint). Perturbations can be sampled based on a prior distribution of expected constraint violations. For example, extreme violations can be sampled less often than slight violations.

Perturbations can be applied in advance (e.g., offline) to create and store a dataset of exemplars for later use. Data augmentation system(s) 802 can perform perturbation on demand during training/validation to generate additional exemplars in real time, decreasing a storage demand and reducing an effective storage footprint of the training/validation dataset.

Perturbations can be applied to attributes of the ego vehicle trajectory itself. For instance, in the above lane change example, a speed of the ego vehicle can be adjusted in lieu of or in addition to a perturbation of the rear actor speed, so long as the suboptimality of the ego vehicle trajectory is preserved.

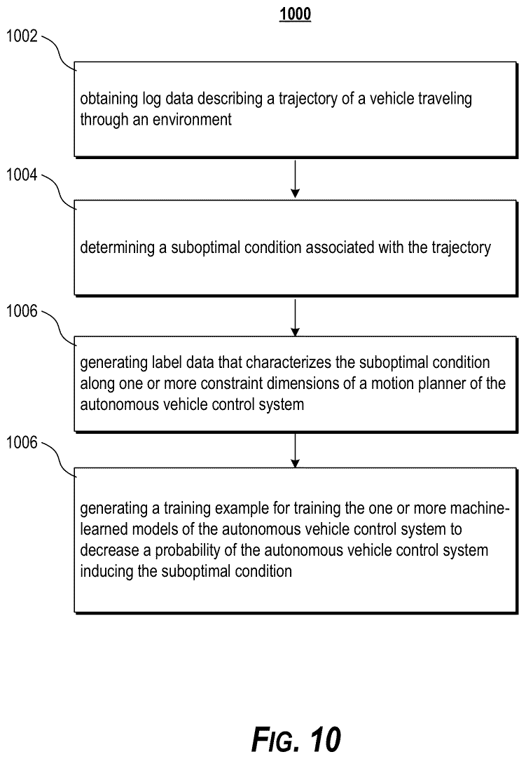

FIG. 9 is an illustration of an example interface of a user input system 900 that human reviewers can use to input corrective actions upon review of logged trajectories. An interface 902 can present a rendering of log data that can be “replayed”—that is, log data at various time steps can be presented in sequence (e.g., controlled by playback controls 904) to facilitate review of the behavior of an ego vehicle 906 in context.

A user can interact with the interface 902 to draw a preferred trajectory 908. Drawing a trajectory can include tracing a path across an input surface (e.g., touch-sensitive input surface, using a cursor, etc.). Drawing a trajectory can include selecting coordinates at which to anchor waypoints for the trajectory. Differences between the preferred trajectory and an actual trajectory taken by ego vehicle 906 can be processed (e.g., by label generation system 422) and stored as corrective actions applied to the actual trajectory.

Interface 902 can record other annotations that indicate corrective actions. Interface 902 can record annotations that indicate a corrective action to slow down, speed up, change lanes, stay in lane, yield, not yield, etc.

A user can interact with the interface 902 to designate time intervals within which the annotations are valid (e.g., an initiation time of a corrective action). For example, interface 902 can receive inputs that associate points on a timeline with beginning and ending times of a time interval. For example, an initial time marker 910 can designate a time at which suboptimal behavior begins. Another suboptimal behavior can designate a time at which the human reviewer confirms the behavior is sufficiently suboptimal to intervene and apply a corrective action.

Interface 902 can provide input fields for recording constraint dimensions violated by any suboptimal behavior as well as directions in which the constraints were violated. Label generation system 422 can preprocess the log data to prepopulate the input fields with initial estimates, and interface 902 can solicit confirmation from a user.

Interface 902 can record annotations indicating relevant actors and objects. Interface 902 can be configured such that clicking on or otherwise selecting an actor can designate the actor as relevant to a determination of suboptimality. Selecting the actor can trigger opening of a dialogue interface to input or confirm any salient attributes and input or confirm any half-space constraints thereon for the purposes of data augmentation.

User input system 900 can be part of or interact with label generation system 900. For instance, label generation system 422 can generate label data 424 by receiving data input by a user via interface 902 and compiling label data 424. User input system 900 can operate to confirm or review automatically generated label data 424 output by label generation system 422.

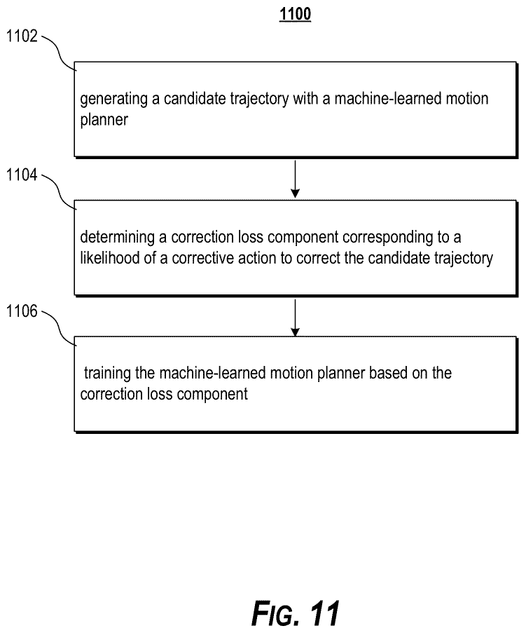

FIG. 10 is a flowchart of method 1000 for performing constraint labeling according to aspects of the present disclosure. One or more portion(s) of the method 1000 can be implemented by a computing system that includes one or more computing devices such as, for example, the computing systems described with reference to the other figures (e.g., autonomous platform 110, vehicle computing system 180, remote system(s) 160, a system of FIG. 13, etc.). Each respective portion of the method 1000 can be performed by any (or any combination) of one or more computing devices. Moreover, one or more portion(s) of method 1000 can be implemented on the hardware components of the device(s) described herein (e.g., as in FIGS. 1, 2, 13, etc.). FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of method 1000 can be performed additionally, or alternatively, by other systems.

At 1002, example method 1000 can include obtaining log data describing a trajectory of a vehicle traveling through an environment. For example, log data can include trajectory data 414 that describes the trajectory using one or more parameter values.

At 1004, example method 1000 can include determining a suboptimal condition associated with the trajectory. For example, an occurrence of a corrective action can signal that at least one aspect of the trajectory was desired to be corrected or improved. Other signals of suboptimal conditions can be used. An example signal is an outlier trajectory parameter value that is beyond a known constraint (e.g., a speed higher than a speed limit).

At 1006, example method 1000 can include generating label data that characterizes the suboptimal condition along one or more constraint dimensions of a motion planner of the autonomous vehicle control system. For example, label generation system 422 can generate label data 424 containing a suboptimal condition indicator 426. The suboptimal condition indicator 426 can identify a corresponding constraint dimension of trajectory constraints 404 that is violated. For example, a constraint dimension can be speed, and the direction of the violation can be exceeding a maximum speed. In this manner, for instance, suboptimal condition indicator 426 can characterize the suboptimal nature of the trajectory in terms of a constraint dimension in trajectory constraints 404.

At 1010, example method 1000 can include generating a training example for training the one or more machine-learned models of the autonomous vehicle control system to decrease a probability of the autonomous vehicle control system inducing the suboptimal condition. In example method 1000, the training example can include at least a suboptimal portion of the trajectory and the label data. For example, a training example can include a labeled trajectory 432. Labeled trajectory 432 can contain strong training signals that can help a model identify suboptimal behaviors and avoid repeating them. Labeled trajectory 432 can be used to determine a loss function that scores outputs of the one or more machine-learned models, and the one or more machine-learned models can be trained to optimize the scores.

In some implementations of example method 1000, the example method 1000 can include determining a corrective action initiated by a human operator of the vehicle, and the vehicle can be an autonomous vehicle. In some implementations of example method 1000, the human operator can be onboard the autonomous vehicle.

In some implementations of example method 1000, the example method 1000 can include determining a corrective action initiated by a human reviewer that reviews the trajectory using a trajectory review system.

In some implementations of example method 1000, the example method 1000 can include determining the one or more constraint dimensions based on one or more features of the corrective action. In some implementations of example method 1000, the suboptimal condition can be characterized based on a magnitude of a change in state associated with the corrective action.

In some implementations of example method 1000, the corrective action can include a braking action or an acceleration action, and the one or more constraint dimensions can correspond to a longitudinal motion parameter. For example, a longitudinal motion parameter can include an in-lane velocity, acceleration, closing distance, following distance, etc. In some implementations of example method 1000, the corrective action can include a steering action, and the one or more constraint dimensions correspond to a lateral motion parameter. For example, a lateral motion parameter can include a lane overlap measure, a lateral velocity, acceleration, closing distance, etc.

In some implementations of example method 1000, the label data can include a direction characteristic that describes a direction of the suboptimality along the one or more constraint dimensions. For instance, the direction characteristic can indicate whether a particular parameter value is too high or too low with respect to a constraint value. In some implementations of example method 1000, the direction characteristic can be determined based on a direction of a corrective action initiated by a human operator.

For example, label generation system 422 can process trajectory data 414 to determine changes in parameter values and associate the changes in parameter values with changes along a constraint dimension. For instance, a sudden change in a brake force can indicate a corrective action with regard to one or more longitudinal motion parameters. If a speed dropped after the corrective action and reached and maintained a steady level after the corrective action, label generation system 422 can determine that the speed was initially suboptimal by being too high along the speed constraint dimension. Similarly, if a closing distance was too low and the closing distance increased after the corrective action, label generation system 422 can determine that the closing distance was initially suboptimal by being too low along a closing distance constraint dimension.

In some implementations of example method 1000, (b) can include receiving an annotation from a user device that indicates a preferred trajectory, different from the trajectory from the log data, that a user inputs in association with the log data. For example, a user input interface 900 can receive input data that indicates a preferred trajectory for an ego vehicle 906 to take in lieu of an existing trajectory of the ego vehicle 906.

In some implementations of example method 1000, the example method 1000 can include determining the suboptimal portion based on an interval that is associated with the suboptimal condition. For example, a suboptimal condition associated with a corrective action (e.g., disengagement, annotation) can split a trajectory into a suboptimal portion that precedes the corrective action and a recovery portion that follows the corrective action. In some implementations of example method 1000, a boundary of the interval can be based on a corrective action initiated by a human operator. In some implementations of example method 1000, a boundary of the interval can be based on a divergence of a preferred trajectory from the trajectory from the log data, the preferred trajectory obtained from a user input associated with the log data.

In some implementations of example method 1000, the example method 1000 can include selecting the trajectory from the log data based on a score computed for the trajectory. For example, label generation system 422 can extract trajectory data 414 from log data 412 based on a score associated with the trajectory described by trajectory data 414. The score can indicate a confidence associated with the trajectory. The score can indicate a cost associated with the trajectory (e.g., as costed by a motion planning system that generated the trajectory, as costed by an external, different motion planning system, etc.).

In some implementations of example method 1000, the example method 1000 can include generating one or more additional training examples from the training example. For instance, example method 1000 can include implementing data augmentation system 802 to increase a number of training examples in a dataset. In some implementations of example method 1000, the example method 1000 can include perturbing a state of a parameter in a direction that increases the suboptimality of the trajectory. The state can include at least one of: (i) a state of the vehicle or (ii) a state of an object in the environment. For example, data augmentation system 802 can increase a closing speed of an approaching rear actor to render an initially suboptimal lane change in front of the rear actor even more suboptimal.

In some implementations of example method 1000, the label data can include: a time interval (e.g., a corrective action start time, a suboptimal interval start time, etc.), a suboptimal state value (e.g., a value of a trajectory parameter associated with the suboptimal condition), and a suboptimality type (e.g., a direction of violation of a constraint).

In some implementations of example method 1000, the example method 1000 can include generating, from the log data, a positive training example for training the machine-learned model to imitate at least a recovery portion of the trajectory, wherein the recovery portion describes the corrective action. For example, a portion of a suboptimal trajectory after the corrective action is applied can provide an expert exemplar of how to recover from a suboptimal situation. In this manner, a portion of the suboptimal trajectory associated with a positive exemplar interval can be extracted as a positive training example.

In some implementations of example method 1000, the suboptimal condition can correspond to a magnitude of first parameter value along a first constraint dimension in combination with a magnitude of a second parameter value along a second constraint dimension (e.g., following distance and lane overlap). In some implementations of example method 1000, the label data can characterize the suboptimal condition along a plurality of constraint dimensions joined by one or more Boolean operators (e.g., AND, OR, XOR, NOT, etc.).

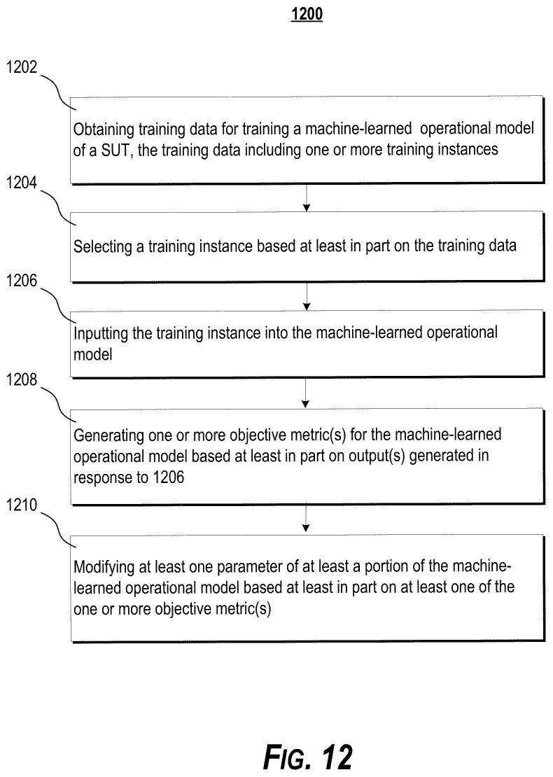

FIG. 11 is a flowchart of method 1100 for training a model using constraint-labeled training examples according to aspects of the present disclosure. One or more portion(s) of the method 1100 can be implemented by a computing system that includes one or more computing devices such as, for example, the computing systems described with reference to the other figures (e.g., autonomous platform 110, vehicle computing system 180, remote system(s) 160, a system of FIG. 13, etc.). Each respective portion of the method 1100 can be performed by any (or any combination) of one or more computing devices. Moreover, one or more portion(s) of method 1100 can be implemented on the hardware components of the device(s) described herein (e.g., as in FIGS. 1, 2, 13, etc.). FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of method 1100 can be performed additionally, or alternatively, by other systems.

At 1102, example method 1100 can include generating a candidate trajectory with a machine-learned motion planner. A candidate trajectory can correspond to generated trajectory(ies) 708.

At 1104, example method 1100 can include determining a correction loss corresponding to a likelihood of a disengagement or other corrective action to correct the candidate trajectory. In example method 1100, the correction loss can be determined based on a negative training example that includes label data that characterizes a suboptimal condition of an example corrected trajectory along one or more constraint dimensions.

At 1106, example method 1100 can include training the machine-learned motion planner based on the correction loss.

In some implementations of example method 1100, the correction loss can be based on a difference between a parameter value of the candidate trajectory and a corresponding parameter value of the example corrected trajectory. For example, a probability of a corrective action occurring can increase if a parameter value of the candidate trajectory exceeds the parameter value that precipitated a correction in the example corrected trajectory. For example, the example corrected trajectory can be associated with labeled data that indicates a particular constraint dimension that was violated in that example corrected trajectory. The correction loss can compare a value of the candidate trajectory along that constraint dimension to the value of the example corrected trajectory along that constraint dimension. In some implementations of example method 1100, the correction loss can include a hinge loss.

In some implementations of example method 1100, the example method 1100 can include generating the correction loss using a machine-learned disengagement predictor trained using the negative training example. For example, disengagement predictor(s) 706 can include a machine-learned model (e.g., a neural network or other machine-learned model) that is configured to process a trajectory and output a score associated with a likelihood of a corrective action being implemented to correct the candidate trajectory. Such a machine-learned model can be trained over a training dataset containing suboptimal trajectories labeled as describer herein.

In some implementations of example method 1100, the example method 1100 can include training the machine-learned motion planner based on a recovery loss corresponding to a similarity between a candidate recovery trajectory implementing a corrective action to correct an initial state of a vehicle, and an example recovery trajectory implementing an example corrective action to correct an initial state of a vehicle.

In some implementations of example method 1100, the example recovery trajectory and the example corrected trajectory can be based on respective portions of a logged trajectory (e.g., the same logged trajectory). In some implementations of example method 1100, the respective portions can be divided based on a time at which a human operator initiated a corrective action. For example, the portions can correspond to a negative exemplar interval 504 and a positive exemplar interval 506 of the same trajectory.

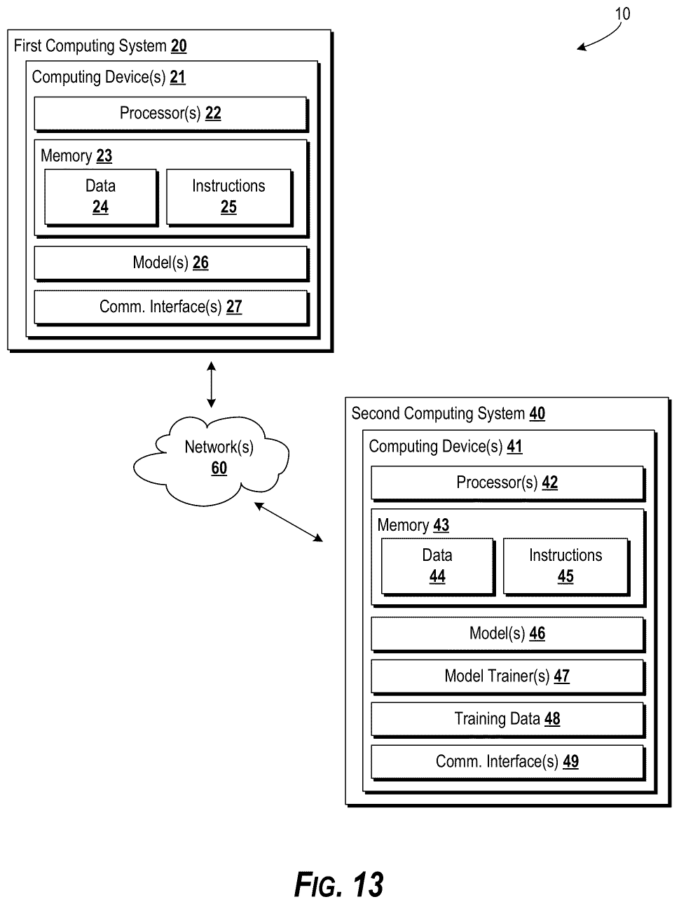

FIG. 12 is a flowchart of method 1200 for training one or more machine-learned operational models according to aspects of the present disclosure.

One or more portion(s) of the method 1200 can be implemented by a computing system that includes one or more computing devices such as, for example, the computing systems described with reference to the other figures (e.g., remote system(s) 160, a system of FIG. 13, etc.). Each respective portion of the method 1200 can be performed by any (or any combination) of one or more computing devices. Moreover, one or more portion(s) of method 1200 can be implemented on the hardware components of the device(s) described herein (e.g., as in FIGS. 1, 2, 13, etc.), for example, to validate one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of method 1200 can be performed additionally, or alternatively, by other systems.

At 1202, method 1200 can include obtaining training data for training a machine-learned operational model. The training data can include a plurality of training instances (e.g., including portions of constraint-labeled trajectories as described herein).

The training data can be collected using one or more autonomous platforms (e.g., autonomous platform 110) or the sensors thereof while the autonomous platform operates within its environment. By way of example, the training data can be collected using one or more autonomous vehicle(s) (e.g., autonomous platform 110, autonomous vehicle 310, autonomous vehicle 350, etc.) or sensors thereof as the vehicle(s) operates along one or more travel ways. In some examples, the training data can be collected using other sensors, such as mobile-device-based sensors, ground-based sensors, aerial-based sensors, satellite-based sensors, or substantially any sensor interface configured for obtaining and/or recording measured data.

The training data can include a plurality of training sequences divided between multiple datasets (e.g., a training dataset, a validation dataset, or testing dataset). Each training sequence can include a plurality of pre-recorded perception datapoints, point clouds, images, etc. In some implementations, each sequence can include LIDAR point clouds (e.g., collected using LIDAR sensors of an autonomous platform), images (e.g., collected using mono or stereo imaging sensors, etc.), and the like. For instance, in some implementations, a plurality of images can be scaled for training and evaluation.

At 1204, method 1200 can include selecting a training instance based at least in part on the training data.

At 1206, method 1200 can include inputting the training instance into the machine-learned operational model.

At 1208, the method 1200 can include generating one or more loss metric(s) and/or one or more objective(s) for the machine-learned operational model based on output(s) of at least a portion of the machine-learned operational model and label(s) associated with the training instances.

At 1210, method 1200 can include modifying at least one parameter of at least a portion of the machine-learned operational model based at least in part on at least one of the loss metric(s) and/or at least one of the objective(s). For example, a computing system can modify at least a portion of the machine-learned operational model based at least in part on at least one of the loss metric(s) and/or at least one of the objective(s).

In some implementations, the machine-learned operational model can be trained in an end-to-end manner. For example, in some implementations, the machine-learned operational model can be fully differentiable.

After being updated, the operational model or the operational system including the operational model can be provided for validation (e.g., according to example implementations of method 1200, etc.). In some implementations, a validation system can evaluate or validate the operational system. The validation system can trigger retraining, decommissioning, etc. of the operational system based on, for example, failure to satisfy a validation threshold in one or more areas. The validation can be based on, for instance, trajectory constraints 404.

FIG. 13 is a block diagram of an example computing ecosystem 10 according to example implementations of the present disclosure. The example computing ecosystem 10 can include a first computing system 20 and a second computing system 40 that are communicatively coupled over one or more networks 60. In some implementations, the first computing system 20 or the second computing 40 can implement one or more of the systems, operations, or functionalities described herein for validating one or more systems or operational systems (e.g., the remote system(s) 160, the onboard computing system(s) 180, the autonomy system(s) 200, etc.).

In some implementations, the first computing system 20 can be included in an autonomous platform and be utilized to perform the functions of an autonomous platform as described herein. For example, the first computing system 20 can be located onboard an autonomous vehicle and implement autonomy system(s) for autonomously operating the autonomous vehicle. In some implementations, the first computing system 20 can represent the entire onboard computing system or a portion thereof (e.g., the localization system 230, the perception system 240, the planning system 250, the control system 260, or a combination thereof, etc.). In other implementations, the first computing system 20 may not be located onboard an autonomous platform. The first computing system 20 can include one or more distinct physical computing devices 21.

The first computing system 20 (e.g., the computing device(s) 21 thereof) can include one or more processors 22 and a memory 23. The one or more processors 22 can be any suitable processing device (e.g., a processor core, a microprocessor, an ASIC, a FPGA, a controller, a microcontroller, etc.) and can be one processor or a plurality of processors that are operatively connected. Memory 23 can include one or more non-transitory computer-readable storage media, such as RAM, ROM, EEPROM, EPROM, one or more memory devices, flash memory devices, etc., and combinations thereof.

Memory 23 can store information that can be accessed by the one or more processors 22. For instance, the memory 23 (e.g., one or more non-transitory computer-readable storage media, memory devices, etc.) can store data 24 that can be obtained (e.g., received, accessed, written, manipulated, created, generated, stored, pulled, downloaded, etc.). The data 24 can include, for instance, sensor data, map data, data associated with autonomy functions (e.g., data associated with the perception, planning, or control functions), simulation data, or any data or information described herein. In some implementations, the first computing system 20 can obtain data from one or more memory device(s) that are remote from the first computing system 20.

Memory 23 can store computer-readable instructions 25 that can be executed by the one or more processors 22. Instructions 25 can be software written in any suitable programming language or can be implemented in hardware. Additionally, or alternatively, instructions 25 can be executed in logically or virtually separate threads on the processor(s) 22.

For example, the memory 23 can store instructions 25 that are executable by one or more processors (e.g., by the one or more processors 22, by one or more other processors, etc.) to perform (e.g., with the computing device(s) 21, the first computing system 20, or other system(s) having processors executing the instructions) any of the operations, functions, or methods/processes (or portions thereof) described herein. For example, operations can include implementing system validation (e.g., as described herein).

In some implementations, the first computing system 20 can store or include one or more models 26. In some implementations, the models 26 can be or can otherwise include one or more machine-learned models (e.g., a machine-learned operational system, etc.). As examples, the models 26 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the first computing system 20 can include one or more models for implementing subsystems of the autonomy system(s) 200, including any of: the localization system 230, the perception system 240, the planning system 250, or the control system 260.

In some implementations, the first computing system 20 can obtain the one or more models 26 using communication interface(s) 27 to communicate with the second computing system 40 over the network(s) 60. For instance, the first computing system 20 can store the model(s) 26 (e.g., one or more machine-learned models) in memory 23. The first computing system 20 can then use or otherwise implement the models 26 (e.g., by the processors 22). By way of example, the first computing system 20 can implement the model(s) 26 to localize an autonomous platform in an environment, perceive an autonomous platform's environment or objects therein, plan one or more future states of an autonomous platform for moving through an environment, control an autonomous platform for interacting with an environment, etc.

The second computing system 40 can include one or more computing devices 41. The second computing system 40 can include one or more processors 42 and a memory 43. The one or more processors 42 can be any suitable processing device (e.g., a processor core, a microprocessor, an ASIC, a FPGA, a controller, a microcontroller, etc.) and can be one processor or a plurality of processors that are operatively connected. The memory 43 can include one or more non-transitory computer-readable storage media, such as RAM, ROM, EEPROM, EPROM, one or more memory devices, flash memory devices, etc., and combinations thereof.

Memory 43 can store information that can be accessed by the one or more processors 42. For instance, the memory 43 (e.g., one or more non-transitory computer-readable storage media, memory devices, etc.) can store data 44 that can be obtained. The data 44 can include, for instance, sensor data, model parameters, map data, simulation data, simulated environmental scenes, simulated sensor data, data associated with vehicle trips/services, or any data or information described herein. In some implementations, the second computing system 40 can obtain data from one or more memory device(s) that are remote from the second computing system 40.

Memory 43 can also store computer-readable instructions 45 that can be executed by the one or more processors 42. The instructions 45 can be software written in any suitable programming language or can be implemented in hardware. Additionally, or alternatively, the instructions 45 can be executed in logically or virtually separate threads on the processor(s) 42.

For example, memory 43 can store instructions 45 that are executable (e.g., by the one or more processors 42, by the one or more processors 22, by one or more other processors, etc.) to perform (e.g., with the computing device(s) 41, the second computing system 40, or other system(s) having processors for executing the instructions, such as computing device(s) 21 or the first computing system 20) any of the operations, functions, or methods/processes described herein. This can include, for example, the functionality of the autonomy system(s) 200 (e.g., localization, perception, planning, control, etc.) or other functionality associated with an autonomous platform (e.g., remote assistance, mapping, fleet management, trip/service assignment and matching, etc.). This can also include, for example, validating a machined-learned operational system.

In some implementations, second computing system 40 can include one or more server computing devices. In the event that the second computing system 40 includes multiple server computing devices, such server computing devices can operate according to various computing architectures, including, for example, sequential computing architectures, parallel computing architectures, or some combination thereof.

Additionally, or alternatively to, the model(s) 26 at the first computing system 20, the second computing system 40 can include one or more models 46. As examples, the model(s) 46 can be or can otherwise include various machine-learned models (e.g., a machine-learned operational system, etc.) such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the second computing system 40 can include one or more models of the autonomy system(s) 200.

In some implementations, the second computing system 40 or the first computing system 20 can train one or more machine-learned models of the model(s) 26 or the model(s) 46 through the use of one or more model trainers 47 and training data 48. The model trainer(s) 47 can train any one of the model(s) 26 or the model(s) 46 using one or more training or learning algorithms. One example training technique is backwards propagation of errors. In some implementations, the model trainer(s) 47 can perform supervised training techniques using labeled training data. In other implementations, the model trainer(s) 47 can perform unsupervised training techniques using unlabeled training data. In some implementations, the training data 48 can include simulated training data (e.g., training data obtained from simulated scenarios, inputs, configurations, environments, etc.). In some implementations, the second computing system 40 can implement simulations for obtaining the training data 48 or for implementing the model trainer(s) 47 for training or testing the model(s) 26 or the model(s) 46. By way of example, the model trainer(s) 47 can train one or more components of a machine-learned model for the autonomy system(s) 200 through unsupervised training techniques using an objective function (e.g., costs, rewards, heuristics, constraints, etc.). In some implementations, the model trainer(s) 47 can perform a number of generalization techniques to improve the generalization capability of the model(s) being trained. Generalization techniques include weight decays, dropouts, or other techniques.

For example, in some implementations, the second computing system 40 can generate training data 48 according to example aspects of the present disclosure. For instance, the second computing system 40 can generate training data 48. For instance, the second computing system 40 can implement methods according to example aspects of the present disclosure. The second computing system 40 can use the training data 48 to train model(s) 26. For example, in some implementations, the first computing system 20 can include a computing system onboard or otherwise associated with a real or simulated autonomous vehicle. In some implementations, model(s) 26 can include perception or machine vision model(s) configured for deployment onboard or in service of a real or simulated autonomous vehicle. In this manner, for instance, the second computing system 40 can provide a training pipeline for training model(s) 26.

The first computing system 20 and the second computing system 40 can each include communication interfaces 27 and 49, respectively. The communication interfaces 27, 49 can be used to communicate with each other or one or more other systems or devices, including systems or devices that are remotely located from the first computing system 20 or the second computing system 40. The communication interfaces 27, 49 can include any circuits, components, software, etc. for communicating with one or more networks (e.g., the network(s) 60). In some implementations, the communication interfaces 27, 49 can include, for example, one or more of a communications controller, receiver, transceiver, transmitter, port, conductors, software or hardware for communicating data.

The network(s) 60 can be any type of network or combination of networks that allows for communication between devices. In some implementations, the network(s) can include one or more of a local area network, wide area network, the Internet, secure network, cellular network, mesh network, peer-to-peer communication link or some combination thereof and can include any number of wired or wireless links. Communication over the network(s) 60 can be accomplished, for instance, through a network interface using any type of protocol, protection scheme, encoding, format, packaging, etc.

FIG. 13 illustrates one example computing ecosystem 10 that can be used to implement the present disclosure. For example one or more systems or devices of ecosystem 10 can implement any one or more of the systems and components described in the preceding figures. Other systems can be used as well. For example, in some implementations, the first computing system 20 can include the model trainer(s) 47 and the training data 48. In such implementations, the model(s) 26, 46 can be both trained and used locally at the first computing system 20. As another example, in some implementations, the computing system 20 may not be connected to other computing systems. Additionally, components illustrated or discussed as being included in one of the computing systems 20 or 40 can instead be included in another one of the computing systems 20 or 40.

Computing tasks discussed herein as being performed at computing device(s) remote from the autonomous platform (e.g., autonomous vehicle) can instead be performed at the autonomous platform (e.g., via a vehicle computing system of the autonomous vehicle), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A computer-implemented method for generating training data for training one or more machine-learned models of an autonomous vehicle control system, comprising:
(a) obtaining log data describing a trajectory of a vehicle traveling through an environment;
(b) determining a suboptimal condition associated with the trajectory;
(c) generating label data that characterizes the suboptimal condition along one or more constraint dimensions of a motion planner of the autonomous vehicle control system; and
(d) generating a training example for training the one or more machine-learned models of the autonomous vehicle control system to decrease a probability of the autonomous vehicle control system inducing the suboptimal condition, wherein the training example comprises at least a suboptimal portion of the trajectory and the label data.

2. The computer-implemented method of claim 1, comprising:
determining a corrective action initiated by a human operator of the vehicle, wherein the vehicle is an autonomous vehicle.

3. The computer-implemented method of claim 2, wherein:
the human operator is onboard the autonomous vehicle.

4. The computer-implemented method of claim 2, comprising:
determining the one or more constraint dimensions based on one or more features of the corrective action.

5. The computer-implemented method of claim 2, wherein:
the suboptimal condition is characterized based on a magnitude of a change associated with the corrective action.

6. The computer-implemented method of claim 4, wherein:
the corrective action comprises a braking action or an acceleration action, and the one or more constraint dimensions correspond to a longitudinal motion parameter; or
the corrective action comprises a steering action, and the one or more constraint dimensions correspond to a lateral motion parameter.

7. The computer-implemented method of claim 1, wherein:
the label data comprises a direction characteristic that describes a direction of the suboptimality along the one or more constraint dimensions.

8. The computer-implemented method of claim 7, wherein:
the direction characteristic is determined based on a direction of a corrective action initiated by a human operator.

9. The computer-implemented method of claim 1, wherein:
(b) comprises receiving an annotation from a user device that indicates a preferred trajectory, different from the trajectory from the log data, that a user inputs in association with the log data.

10. The computer-implemented method of claim 1, comprising:
determining the suboptimal portion based on an interval that is associated with the suboptimal condition.

11. The computer-implemented method of claim 10, wherein:
a boundary of the interval is based on a corrective action initiated by a human operator; or
a boundary of the interval is based on a divergence of a preferred trajectory from the trajectory from the log data, the preferred trajectory obtained from a user input associated with the log data.

12. The computer-implemented method of claim 1, comprising:
selecting the trajectory from the log data based on a score computed for the trajectory.

13. The computer-implemented method of claim 1, comprising:
generating one or more additional training examples from the training example by:
perturbing a state in a direction that increases the suboptimality of the trajectory, the state comprising at least one of: (i) a state of the vehicle or (ii) a state of an object in the environment.

14. The computer-implemented method of claim 1, wherein:
the label data comprises: a time interval, a suboptimal state value, and a suboptimality type.

15. The computer-implemented method of claim 2, comprising:
generating, from the log data, a positive training example for training the machine-learned model to imitate at least a recovery portion of the trajectory, wherein the recovery portion describes the corrective action.

16. The computer-implemented method of claim 1, wherein:
the label data characterizes the suboptimal condition along a plurality of constraint dimensions joined by one or more Boolean operators.

17. The computer-implemented method of claim 16, wherein:
the suboptimal condition corresponds to a magnitude of first parameter value along a first constraint dimension in combination with a magnitude of a second parameter value along a second constraint dimension.

18. A computing system, comprising:
one or more processors; and
one or more non-transitory, computer-readable media storing instructions that are executable by the one or more processors to cause the computing system to perform operations, the operations comprising:
(a) obtaining log data describing a trajectory of a vehicle traveling through an environment;
(b) determining a suboptimal condition associated with the trajectory;
(c) generating label data that characterizes the suboptimal condition along one or more constraint dimensions of a motion planner of the autonomous vehicle control system; and
(d) generating a training example for training one or more machine-learned models of an autonomous vehicle control system to decrease a probability of the autonomous vehicle control system inducing the suboptimal condition, wherein the training example comprises at least a suboptimal portion of the trajectory and the label data.

19. The computing system of claim 18, the operations comprising:
determining a corrective action initiated by a human operator of the vehicle, wherein the vehicle is an autonomous vehicle.

20. One or more non-transitory, computer-readable media storing instructions that are executable by one or more processors to cause a computing system to perform operations, the operations comprising:
(a) obtaining log data describing a trajectory of a vehicle traveling through an environment;
(b) determining a suboptimal condition associated with the trajectory;
(c) generating label data that characterizes the suboptimal condition along one or more constraint dimensions of a motion planner of the autonomous vehicle control system; and
(d) generating a training example for training one or more machine-learned models of an autonomous vehicle control system to decrease a probability of the autonomous vehicle control system inducing the suboptimal condition, wherein the training example comprises at least a suboptimal portion of the trajectory and the label data.
